(19) United States
(12) Patent Application Publication
(10) Pub. No.: US 2016/0308600 A1
(43) Pub. Date: Oct. 20, 2016

(54) BASE STATION APPARATUS, TERMINAL APPARATUS, AND WIRELESS ACCESS SYSTEM

(71) Applicant: FUJITSU LIMITED, Kawasaki-shi (JP)

(72) Inventors: Daisuke Nitta, Plano, TX (US); Satoshi Yamamoto, Fuchu (JP)

(73) Assignee: FUJITSU LIMITED, Kawasaki-shi (JP)

(21) Appl. No.: 15/191,979

(22) Filed: Jun. 24, 2016

Related U.S. Application Data
(63) Continuation of application No. PCT/JP2013/085259, filed on Dec. 27, 2013.

(51) Int. Cl. H04B 7/14; H04W 4/00; H04W 48/02; H04W 76/02

(52) U.S. Cl. CPC H04B 7/14; H04W 76/023; H04W 4/005; H04W 48/02; H04W 88/08

(57) ABSTRACT

A base station apparatus includes a receiving circuit configured to receive from a first terminal apparatus, a start request for direct wireless communication between the first terminal apparatus and a second terminal apparatus; and a transmitting circuit configured transmit to the first terminal apparatus and the second terminal apparatus after the receiving circuit receives the start request, a control signal allowing the first terminal apparatus and the second terminal apparatus to mutually transmit signals so as to establish the direct wireless communication.

### CROSS REFERENCE TO RELATED APPLICATIONS

This application is a continuation application of International Application PCT/JP2013/085259, filed on Dec. 27, 2013 and designating the U.S., the entire contents of which are incorporated herein by reference.

### FIELD

The embodiments discussed herein are related to a base station apparatus, a terminal apparatus, and a wireless access system.

### BACKGROUND

A technique is conventionally known that converts a communication protocol of a machine-to-machine (M2M) terminal capable of inter-terminal communication so as to connect the terminal to a network provided by a base station (see, e.g., Japanese Laid-Open Patent Publication No. 2012-124602). A technique is also known that is related to a base station having a function of connecting to an M2M terminal and a function of connecting to a non-M2M terminal (see. e.g., Published Japanese-Translation of PCT Application, Publication No. 2013-506387).

Nonetheless, the conventional techniques have a problem in that since terminals wirelessly communicate with each other directly and not through a base station, the base station is unable to manage the direct wireless communication between terminal apparatuses.

### SUMMARY

According to an aspect of an embodiment, a base station apparatus includes a receiving circuit configured to receive from a first terminal apparatus, a start request for direct wireless communication between the first terminal apparatus and a second terminal apparatus; and a transmitting circuit configured transmit to the first terminal apparatus and the second terminal apparatus after the receiving circuit receives the start request, a control signal allowing the first terminal apparatus and the second terminal apparatus to mutually transmit signals so as to establish the direct wireless communication.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a functional configuration of a wireless access system;

FIG. 2 is an explanatory diagram of an example of the wireless access system;

FIG. 3A is an explanatory diagram (part 1) of an overview of communication in the wireless access system according to a first embodiment;

FIG. 3B is an explanatory diagram (part 2) of an overview of communication in the wireless access system according to the first embodiment;

FIG. 4 is a block diagram of a specific example of a functional configuration of the wireless access system according to the first embodiment;

FIG. 5 is an explanatory diagram (part 1) of an example of communication paths in the wireless access system according to the first embodiment;

FIG. 6 is an explanatory diagram of an example of a format of a search signal;

FIG. 7 is an explanatory diagram of an example of a format of usage status for D2D communication;

FIG. 8 is an explanatory diagram (part 2) of an example of communication paths in the wireless access system according to the first embodiment;

FIG. 9 is an explanatory diagram (part 3) of an example of communication paths in the wireless access system according to the first embodiment;

FIG. 10 is an explanatory diagram of an example of a message for confirming whether another base station can be connected for proxy communication;

FIG. 11 is an explanatory diagram of an example of a D2D communication connection response message from another base station;

FIG. 12 is a diagram of an example of a hardware configuration of a computer apparatus;

FIG. 13 is a flowchart of an example of an algorithm of a line switching determination based on communication quality;

FIG. 14 is a sequence diagram of an example of an operation of starting the D2D communication between terminal apparatuses and switching the D2D communication to communication through a base station apparatus;

FIG. 15 is a sequence diagram of an example of an operation of starting the D2D communication between the terminal apparatuses and switching the D2D communication to the proxy communication through another base station apparatus;

FIG. 16 is an explanatory diagram of an overview of communication in the wireless access system of a second embodiment;

FIG. 17A is an explanatory diagram of an example of communication paths in the wireless access system according to the second embodiment;

FIG. 17B is an explanatory diagram of an example of a format of resource status;

FIG. 18 is a flowchart of an example of an algorithm of line establishment based on an available resource;

FIG. 19 is a sequence diagram of an example of an operation of starting the D2D communication between the terminal apparatuses and establishing two communications including the communication with a base station and the D2D communication;

FIG. 20A is an explanatory diagram (part 1) of an overview of communication in the wireless access system according to a third embodiment;

FIG. 20B is an explanatory diagram (part 2) of an overview of communication in the wireless access system according to the third embodiment;

FIG. 21 is an explanatory diagram of an example of communication paths in the wireless access system according to the third embodiment;

FIG. 22 is a flowchart of an example of an algorithm of referring to a search signal;

FIG. 23 is a sequence diagram of an example of an operation of starting the proxy communication at a base station;

FIG. 24 is a sequence diagram of an example of an operation of starting the respective proxy communications at respective base stations;

FIG. 25 is an explanatory diagram of an overview of communication in the wireless access system according to a fourth embodiment;

FIG. 26 is a block diagram of a specific example of a functional configuration of the wireless access system according to the fourth embodiment;

FIG. 27A is an explanatory diagram of an example (part 1) of communication paths in the wireless access system according to the fourth embodiment;

FIG. 27B is an explanatory diagram of an example (part 2) of communication paths in the wireless access system according to the fourth embodiment; and

FIG. 28 is a sequence diagram of an example of an operation of allowing a terminal apparatus that performs D2D communication and a terminal apparatus that does not support the D2D communication to communicate with each other.

### DESCRIPTION OF THE INVENTION

First to fourth embodiments of a base station apparatus, a terminal apparatus, and wireless access system according to the present invention will be described in detail with reference to the accompanying drawings.

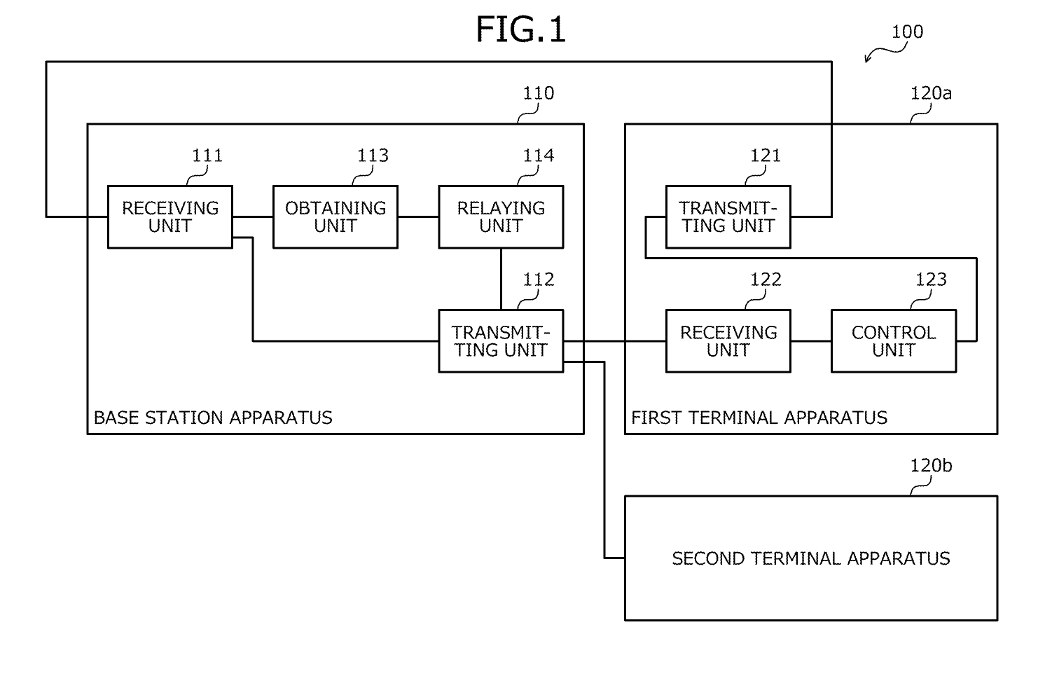

FIG. 1 is a block diagram of a functional configuration of a wireless access system. In FIG. 1, a wireless access system 100 has a base station apparatus 110 and terminal apparatuses 120. The base station apparatus 110 has a receiving unit 111, a transmitting unit 112, an obtaining unit 113, and a relaying unit 114.

The receiving unit 111 receives from the first terminal apparatus 120a, a start request for direct wireless communication between a first terminal apparatus 120a and a second terminal apparatus 120b. Direct wireless communication is, for example, a device-to-device (D2D) communication. Direct wireless communication uses a frequency band different from that of a communication scheme such as radio resource control (RRC) for communication with a base station, for example.

After the receiving unit 111 receives the start request, the transmitting unit 112 transmits a control signal to the first terminal apparatus 120a and the second terminal apparatus 120b. The control signal is a signal for allowing the first terminal apparatus 120a and the second terminal apparatus 120b to mutually transmit signals to establish direct wireless communication. The signals transmitted between the first terminal apparatus 120a and the second terminal apparatus 120b are, for example, search signals and signals for performing handshake.

For example, the transmitting unit 112 may transmit the control signal to the first terminal apparatus 120a and the second terminal apparatus 120b depending on a condition corresponding to the first terminal apparatus 120a and the second terminal apparatus 120b. The condition is, for example, a condition that the first terminal apparatus 120a and the second terminal apparatus 120b have authority to perform direct wireless communication.

When receiving the control signal, the first terminal apparatus 120a and the second terminal apparatus 120b mutually transmit signals to establish direct wireless communication. The first terminal apparatus 120a and the second terminal apparatus 120b mutually transmit the signals by the same communication scheme used for direct wireless communication, for example.

For example, the first terminal apparatus 120a has a transmitting unit 121, a receiving unit 122, and a control unit 123. The transmitting unit 121 transmits to the base station apparatus 110, a start request for direct wireless communication between the first terminal apparatus 120a and another terminal apparatus. After the transmitting unit 121 transmits the start request, the receiving unit 122 receives from the base station apparatus 110, a control signal for establishing the direct wireless communication.

In response to the receiving unit 122 receiving the control signal, the control unit 123 (the first terminal apparatus 120a) mutually transmits signals with the other terminal apparatus (the second terminal apparatus 120b) to establish direct wireless communication. For example, the control unit 123 establishes the direct wireless communication on the condition that the receiving unit 122 receives the control signal and, does not establish direct wireless communication if the receiving unit 122 does not receive the control signal. For example, the control unit 123 mutually transmits with the other terminal apparatus, search signals that indicate a target terminal name and a source terminal name and the control unit 123 refers to the target terminal name and the source terminal name, whereby the direct wireless communication is established.

As a result, the base station apparatus 110 can manage the execution of the direct wireless communication to grant permission.

If direct wireless communication is established, the transmitting unit 121 transmits to the base station apparatus 110, information concerning the result of the direct wireless communication. This information includes start information that indicates establishment of the direct wireless communication, termination information that indicates termination of the direct wireless communication when the direct wireless communication is terminated, etc. The information may also include information that indicates the amount of data transmitted/received between the first terminal apparatus 120a and the second terminal apparatus 120b, the communication time, and communication quality when the direct wireless communication was performed.

The transmitting unit 121 may collectively transmit the information concerning the result of the direct wireless communication when the direct wireless communication ends. The information may be transmitted not only from the transmitting unit 121 of the first terminal apparatus 120a to the base station apparatus 110 but also from the second terminal apparatus 120b to the base station apparatus 110.

As a result, the base station apparatus 110 can manage direct wireless communication between the first terminal apparatus 120a and the second terminal apparatus 120b with an understanding of the details of the communication.

In this case, the first terminal apparatus 120a and the second terminal apparatus 120b sequentially transmit, as search signals to an external destination, for example, information that indicates wireless propagation quality therebetween and information that indicates wireless propagation quality with respect to the base station apparatus 110 and another base station apparatus. From the received search signal, the base station apparatus 110 can obtain the wireless propagation quality between the terminal apparatuses 120a, 120b; between the first terminal apparatus 120a and the base station apparatus 110; and between the second terminal apparatus 120b and the base station apparatus 110.

The obtaining unit 113 obtains the information that indicates the wireless propagation quality between the first terminal apparatus 120a and the second terminal apparatus 120b. The information that indicates the wireless propagation quality between the first terminal apparatus 120a and the second terminal apparatus 120b is, for example, the radio wave reception strength between the first terminal apparatus 120a and the second terminal apparatus 120b, and is information that indicates whether direct wireless communication can be performed.

The relaying unit 114 prohibits direct wireless communication when the wireless propagation quality indicted by the information obtained by the obtaining unit 113 does not satisfy a predetermined condition. A case of not satisfying a predetermined condition is, for example, a case where the radio wave reception strength between the terminal apparatuses 120a, 120b is less than or equal to a predetermined value due to a long distance between the terminal apparatuses 120a, 120b, i.e., a case where direct wireless communication is difficult to perform.

If the predetermined condition is not satisfied, the relaying unit 114 wirelessly communicates with the first terminal apparatus 120a and the second terminal apparatus 120b by a predetermined communication scheme so as to relay the communication between the first terminal apparatus 120a and the second terminal apparatus 120b. The predetermined communication scheme is the same communication scheme used for direct wireless communication. The communication scheme is, for example, communication that uses signals having the same frequency as the signals in the D2D communication or that uses signals of the same type as the signals in the D2D communication. The relay of communication performed by the relaying unit 114 is referred to as proxy communication.

As a result, when direct wireless communication cannot be performed, proxy communication is performed by the same communication scheme used for direct wireless communication and therefore, communication equivalent to the direct wireless communication can be performed between the terminal apparatuses 120a, 120b. Since the proxy communication by the base station apparatus 110 has a higher radio wave strength as compared to the direct wireless communication between the terminal apparatuses 120a, 120b, the communication can be performed with higher quality as compared to the direct wireless communication. Since the direct wireless communication uses a frequency band that differs from the communication scheme for communication with a base station, the communication can be performed without impinging on other frequency bands.

If the wireless propagation quality does not satisfy the predetermined condition when the receiving unit 111 receives the start request, the relaying unit 114 starts the proxy communication without starting the direct wireless communication. To prevent the direct wireless communication from starting, the transmitting unit 112 may refrain from transmitting the control signal described above to the first terminal apparatus 120a and the second terminal apparatus 120b or may transmit a signal to stop the direct wireless communication.

As a result, when the direct wireless communication cannot be started, the proxy communication is performed by the same communication scheme used for direct wireless communication and therefore, communication equivalent to the direct wireless communication can be performed. Communication in a case where the wireless propagation quality does not satisfy the predetermined condition when the receiving unit 111 receives the start request will be described in detail in the third embodiment.

The obtaining unit 113 obtains information that indicates the wireless propagation quality during the direct wireless communication. The obtaining unit 113 obtains information that indicates wireless propagation quality by receiving the information from the terminal apparatus 120a and the terminal apparatus 120b, respectively, by the same wireless scheme as the direct wireless scheme.

When the wireless propagation quality no longer satisfies the predetermined condition during the direct wireless communication, the relaying unit 114 terminates the direct wireless communication and starts the proxy communication. For example, the relaying unit 114 starts the proxy communication when the radio wave reception strength between the first terminal apparatus 120a and the second terminal apparatus 120b becomes less than or equal to a predetermined value. To terminate the direct wireless communication, the transmitting unit 112 transmits to the terminal apparatus 120a and the terminal apparatus 120b, for example, a signal to stop the direct wireless communication.

As a result, if the direct wireless communication becomes unsustainable during execution of the direct wireless communication, the proxy communication is performed by the same communication scheme used for direct wireless communication and therefore, the communication between the terminal apparatuses 120a, 120b can be performed continuously without dropping the communication.

If the wireless propagation quality comes to satisfy the predetermined condition during the proxy communication, the relaying unit 114 may terminate the proxy communication and start direct wireless communication. In particular, if the wireless propagation quality improves between the first terminal apparatus 120a and the second terminal apparatus 120b, the proxy communication may be terminated. As a result, for example, the assurance of an available line for proxy communication can be facilitated and when wireless propagation quality has degraded, direct wireless communication can be preferentially switched to proxy communication.

In this case, the base station apparatus 110 obtains wireless propagation qualities from the search signals received from the first terminal apparatus 120a and the second terminal apparatus 120b and shares the wireless propagation qualities with another base station apparatus. For example, the base station apparatus 110 is assumed to receive from the first terminal apparatus 120a, a start request for a direct wireless communication with the second terminal apparatus 120b. In this case, the base station apparatus 110 refers to the search signal of the first terminal apparatus 120a and the search signal of the second terminal apparatus 120b transmitted from another base station if the terminal apparatus 120b is not present within the cell of the base station apparatus 110.

When referring to the search signals, for example, the base station apparatus 110 establishes the communication between the first terminal apparatus 120a and the second terminal apparatus 120b if the target terminal names and the source terminal names match each other. For example, the base station apparatus 110 and the first terminal apparatus 120a communicate by the same communication scheme used for direct wireless communication, and the other base station apparatus and the second terminal apparatus 120b communicate by the same communication scheme used for direct wireless communication. Through a connection of the base station apparatus 110 and the other base station apparatus, the communication between the first terminal apparatus 120a and the second terminal apparatus 120b is established.

For example, the obtaining unit 113 obtains information that indicates a first wireless propagation quality between the base station apparatus 110 and the second terminal apparatus 120b and a second wireless propagation quality between the other base station apparatus and the second terminal apparatus 120b.

If the wireless propagation quality between the first terminal apparatus 120a and the second terminal apparatus 120b does not satisfy a predetermined condition, the relaying unit 114 switches between a first relay and a second relay. For example, the relaying unit 114 switches between the first relay and the second relay depending on a comparison result of the first wireless propagation quality and the second wireless propagation quality based on the information obtained by the obtaining unit 113.

The first relay is a relay of communication between the first terminal apparatus 120a and the second terminal apparatus 120b by the base station apparatus 110 wirelessly communicating with the first terminal apparatus 120a and communicating with the second terminal apparatus 120b via the other base station apparatus. The second relay is a relay of communication between the first terminal apparatus 120a and the second terminal apparatus 120b by the base station apparatus 110 wirelessly communicating with the first terminal apparatus 120a and the second terminal apparatus 120b.

For example, when the first wireless propagation quality is poorer than the second wireless propagation quality, the first relay is performed via the other base station. If the first wireless propagation quality is better than the second wireless propagation quality, the second relay is performed by only the base station apparatus 110. The base station apparatus 110 and the other base station apparatus are connected through communication that differs from the communication between the terminal apparatuses 120a, 120b, and are connected through a network such as a local area network (LAN) or a wide area network (WAN), for example. The other base station apparatus, similar to the base station apparatus 110, has a function of the proxy communication and performs the proxy communication with the second terminal apparatus 120b.

As a result, even when the first wireless propagation quality is poor between the second terminal apparatus 120b and the base station apparatus 110, the first terminal apparatus 120a and the second terminal apparatus 120b can be connected for communication by performing the first relay via the other base station. Since the other base station apparatus performs the proxy communication with the second terminal apparatus 120b, the other base station apparatus can communicate with the second terminal apparatus 120b by the same communication scheme used for direct wireless communication. As a result, for example, even if the second terminal apparatus 120b performing the direct wireless communication is located in the vicinity of the other base station, the communication between the terminal apparatuses 120a, 120b can be performed continuously without dropping the communication.

The relaying unit 114 starts the first relay via the other base station apparatus or the second relay without starting the direct wireless communication depending on a result of comparison between the first wireless propagation quality and the second wireless propagation quality when the receiving unit 111 receives the start request.

As a result, even when the first wireless propagation quality is poor between the second terminal apparatus 120b and the base station apparatus 110, communication between the first terminal apparatus 120a and the second terminal apparatus 120b can be started by performing the first relay via the other base station. Since the other base station apparatus performs the proxy communication with the second terminal apparatus 120b, the other base station apparatus can start communication with the second terminal apparatus 120b by the same communication scheme used for direct wireless communication. Communication in a case where the wireless propagation quality does not satisfy the predetermined condition when the receiving unit 111 receives the start request will be described in detail in the third embodiment.

The obtaining unit 113 obtains information that indicates the first wireless propagation quality and the second wireless propagation quality during the direct wireless communication. The relaying unit 114 terminates the direct wireless communication and starts the first relay via the other base station apparatus or the second relay depending on a comparison result of the first wireless propagation quality and second wireless propagation quality during the direct wireless communication.

As a result, even if the first wireless propagation quality between the second terminal apparatus 120b and the base station apparatus 110 becomes poor during the direct wireless communication, the communication between the first terminal apparatus 120a and the second terminal apparatus 120b can be continued by performing the first relay. Since the other base station apparatus performs the proxy communication with the second terminal apparatus 120b, the other base station apparatus can continue the communication with the second terminal apparatus 120b by the same communication scheme used for direct wireless communication.

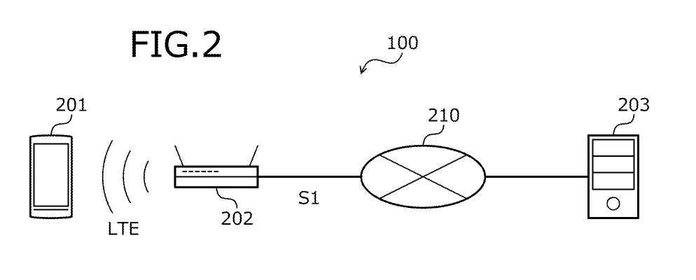

FIG. 2 is an explanatory diagram of an example of the wireless access system. As depicted in FIG. 2, the wireless access system 100 has a terminal apparatus 201, a base station apparatus 202, and an operator station building apparatus 203. The terminal apparatus 201 corresponds to the first terminal apparatus 120a and the second terminal apparatus 120b in FIG. 1. The base station apparatus 202 corresponds to the base station apparatus 110 in FIG. 1.

The terminal apparatus 201 is user equipment (UE) and is a computer apparatus such as a smartphone, a tablet terminal, and a portable telephone used by a user. The terminal apparatus 201 is compliant with the Long Term Evolution-Advance (LTE-A) communication standard. Long Term Evolution (LTE) is a registered trademark. The terminal apparatus 201 can perform D2D communication directly with the other terminal apparatus 201 without the base station apparatus 202. D2D communication can be used for transmitting and receiving data, and making telephone calls.

The base station apparatus 202 is a base station compliant with the LTE-A communication standard. The base station apparatus 202 is, for example, a femtocell base station and builds a communication area with a radius of tens of meters. The terminal apparatus 201 and the base station apparatus 202 can communicate according to the LTE-A scheme communication standard. The operator station building apparatus 203 is a computer apparatus disposed in a mobile operator station building. The base station apparatus 202 and the operator station building apparatus 203 are communicably connected through a fixed communication network 210.

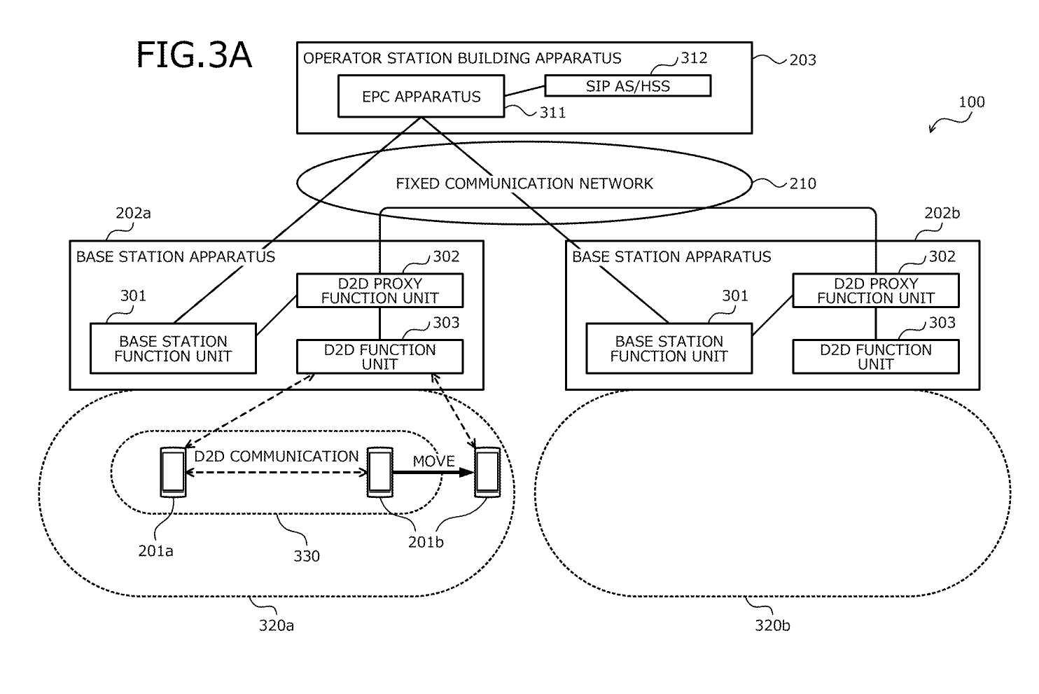

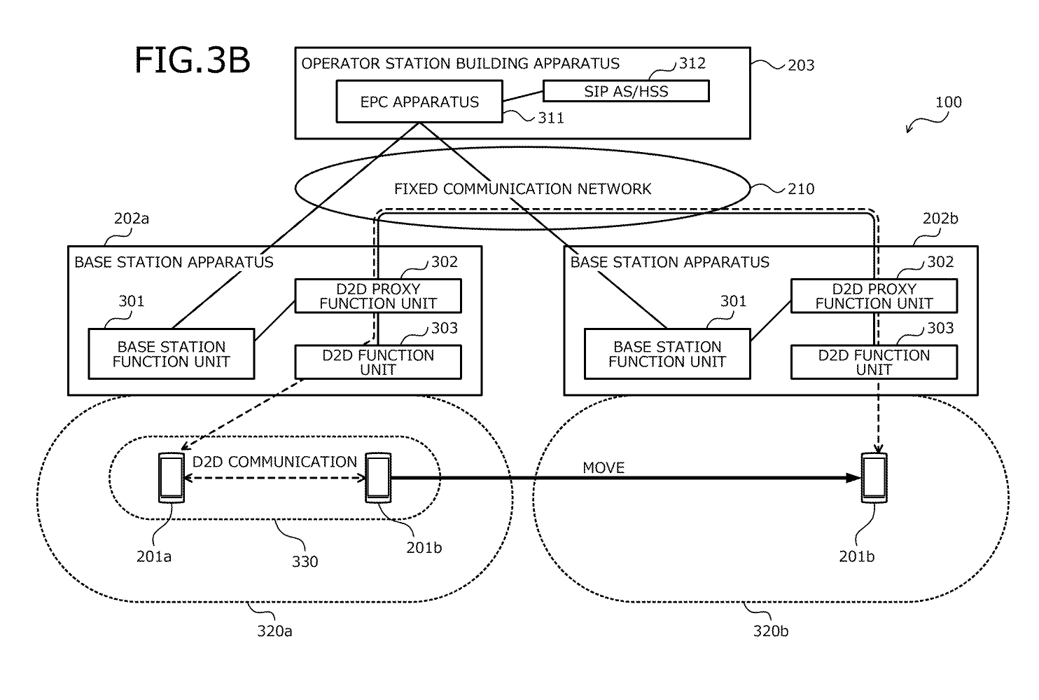

FIG. 3A is an explanatory diagram (part 1) of an overview of communication in the wireless access system according to the first embodiment. As depicted in FIG. 3A, the wireless access system 100 has multiple base station apparatuses 202a, 202b. The base station apparatus 202a has a communication area 320a. The base station apparatus 202b has a communication area 320b.

Each of the base station apparatuses 202a, 202b has a base station function unit 301, a D2D proxy function unit 302, and a D2D function unit 303. The base station function unit 301 is a functional unit that communicates with the operator station building apparatus 203 via the fixed communication network 210. The base station function unit 301 performs communication by the communication scheme for communication with a base station. The communication scheme for communication with a base station is RRC, for example.

The D2D proxy function unit 302 is a functional unit that performs communication by a D2D communication scheme that differs from the communication scheme for communication with a base station. For example, D2D communication uses a frequency band that is narrower than that used for communication with a base station and has a communication speed that is slower than the communication with a base station.

The D2D proxy function unit 302 of the base station apparatus 202a (202b) connects to the D2D proxy function unit 302 of the base station apparatus 202b (202a) within a communication area via the fixed communication network 210 without connecting to the operator station building apparatus 203. The D2D function unit 303 is a functional unit that communicates with the terminal apparatuses 201a, 201b by the same communication scheme used for the D2D communication performed between the terminal apparatuses 201. Hereinafter, the base station apparatus 202a may be referred to as “a base station” as appropriate and the base station apparatus 202b may be referred to as “the other base station” as appropriate.

The operator station building apparatus 203 has an Evolved Packet Core (EPC) apparatus 311 and a Session Initiation Protocol Application Server/Home Subscriber Server (SIP AS/HSS) 312.

The EPC apparatus 311 is an LTE core device defined by the 3rd Generation Partnership Project (3GPP). The 3GPP is a registered trademark. The EPC apparatus 311 has a function of terminating the S1 interface from the base station apparatus 202.

The SIP AS/HSS 312 is a functional unit that relays a connection control signal between the terminal apparatuses 201 to perform the D2D communication. The SIP AS/HSS 312 has a SIP AS and an HSS. The SIP AS executes signaling/session processing and management between the terminal apparatuses 201. The HSS manages subscriber information. The fixed communication network 210 is a wide area Ethernet network, an optical fiber network, and the like connecting the base station function unit 301 and the EPC apparatus 311. Ethernet is a registered trademark.

Here, it is assumed that the terminal apparatuses 201a, 201b are performing the D2D communication in the communication area 320a of the base station apparatus 202a. When performing the D2D communication, the terminal apparatus 201a and the terminal apparatus 201b are located in each other's constructed D2D communication area. For example, the terminal apparatus 201b is located in a D2D communication area 330 of the terminal apparatus 201a. Since the radio wave strength of the terminal apparatus 201 is weaker than the radio wave strength of the base station apparatus 202, for example, the D2D communication area 330 of the terminal apparatus 201a has a smaller range than the communication area 320a of the base station apparatus 202a.

Here, it is assumed that the terminal apparatus 201b has moved to be outside the D2D communication area 330 of the terminal apparatus 201a. As a result, the radio wave strength weakens between the terminal apparatus 201a and the terminal apparatus 201b, making the D2D communication difficult to perform. Therefore, the base station apparatus 202a performs the function of the D2D communication as a proxy.

For example, the D2D function unit 303 relays the communication between the terminal apparatus 201a and the terminal apparatus 201b (performs the proxy communication) by the same communication scheme used for D2D communication and thereby, continues the communication. As a result, even when the D2D communication can no longer be performed between the terminal apparatus 201a and the terminal apparatus 201b, the proxy communication is performed by the same communication scheme used for D2D communication and therefore, the communication between the terminal apparatuses 201a, 201b can continuously be performed without dropping the communication.

FIG. 3B is an explanatory diagram (part 2) of an overview of communication in the wireless access system according to the first embodiment. In FIG. 3B, description will be made of a case where the terminal apparatus 201b has moved outside the communication area 320a of the base station apparatus 202a into the communication area 320b of the base station apparatus 202b.

As depicted in FIG. 3B, it is assumed that the terminal apparatus 201b has moved from the D2D communication area 330 of the terminal apparatus 201a into the communication area 320b of the base station apparatus 202b. Consequently, the D2D communication between the terminal apparatus 201a and the terminal apparatus 201b becomes difficult. Therefore, the base station apparatus 202a and the base station apparatus 202b perform the function of the D2D communication as proxies.

For example, the D2D proxy function units 302 and the D2D function units 303 of the base station apparatus 202a and the base station apparatus 202b relay the communication between the terminal apparatus 201a and the terminal apparatus 201b (perform the proxy communication) by the same communication scheme used for D2D communication. As a result, even when the D2D communication can no longer be performed between the terminal apparatus 201a and the terminal apparatus 201b, the proxy communication is performed and therefore, the communication between the terminal apparatuses 201a, 201b can be performed continuously without dropping the communication.

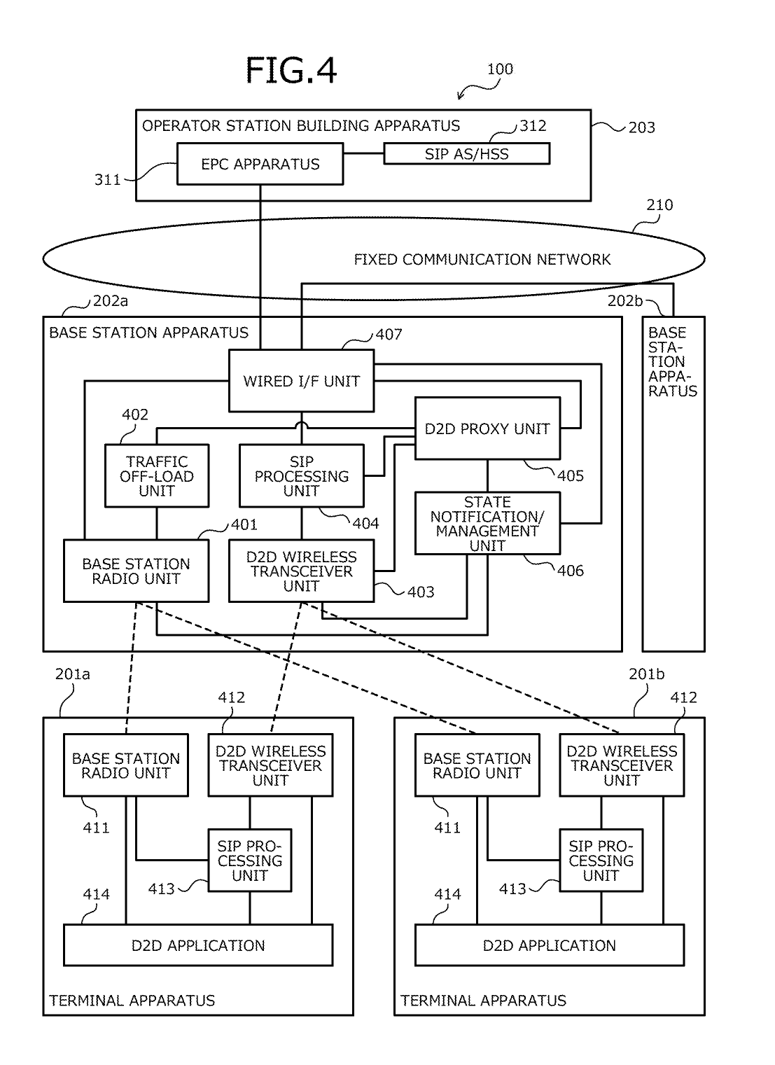

FIG. 4 is a block diagram of a specific example of a functional configuration of the wireless access system according to the first embodiment. As depicted in FIG. 4, the base station apparatus 202a has a base station radio unit 401, a traffic off-load unit 402, a D2D wireless transceiver unit 403, an SIP processing unit 404, a D2D proxy unit 405, a state notification/management unit 406, and a wired interface (I/F) unit 407.

The base station radio unit 401 is a wireless transceiver unit that connects to the terminal apparatuses 201a, 201b by an LTE-A scheme. The LTE-A scheme includes a frequency division duplex (FDD) scheme and a time division duplex (TDD) scheme. The base station radio unit 401 is connected to the traffic off-load unit 402 and a radio unit 411 of the terminal apparatus 201 and is also connected via the wired I/F unit 407 to the EPC apparatus 311.

The traffic off-load unit 402 is compliant with the 3GPP standard, Selected IP Traffic Offload (SIPTO) etc., and off-loads communication contents of a user terminal (user traffic) to the D2D proxy unit 405. If the traffic off-load unit 402 does not off-load the traffic, all the user terminals are connected to the EPC apparatus 311. The traffic off-load unit 402 is connected to the base station radio unit 401 and the D2D proxy unit 405.

The D2D wireless transceiver unit 403 is a wireless transceiver unit that establishes the proxy communication with the terminal apparatuses 201a, 201b, which support the D2D communication. For example, the D2D wireless transceiver unit 403 supports a wireless scheme such as the TDD. The D2D wireless transceiver unit 403 is connected to the SIP processing unit 404, the D2D proxy unit 405, the state notification/management unit 406, and a D2D wireless transceiver unit 412 of the terminal apparatus 201.

The SIP processing unit 404 performs SIP signaling for the D2D communication so as to implement direct data communication between a terminal apparatus 201 that does not support the D2D (described later) and the terminal apparatuses 201a, 201b that support the D2D, for example. For example, the SIP processing unit 404 performs the SIP signaling with the SIP AS/HSS 312 of the operator station building apparatus 203. The SIP processing unit 404 is connected to the D2D wireless transceiver unit 403, the D2D proxy unit 405, and the wired I/F unit 407.

The D2D proxy unit 405 relays user data and SIP signaling so as to perform the D2D communication with the terminal apparatuses 201a, 201b in the communication area of the base station of the base station apparatus 202a and the terminal apparatuses 201a, 201b in the communication area of the base station of the base station apparatus 202b. The D2D proxy unit 405 is connected to the traffic off-load unit 402, the D2D wireless transceiver unit 403, the SIP processing unit 404, the state notification/management unit 406, and the wired I/F unit 407.

The state notification/management unit 406 has a function of collecting and managing information concerning the resource status of the terminal apparatuses 201a, 201b in the communication area of the base station of the base station apparatus 202a, a function of notifying the base station apparatus 202b of the resource status, and a function of receiving and managing notifications from the base station apparatus 202b. The resource status includes, for example, a connected terminal name, the number of connected lines, and a communication band usage rate. The state notification/management unit 406 is connected to the base station radio unit 401, the D2D wireless transceiver unit 403, the D2D proxy unit 405, and the wired I/F unit 407.

The wired I/F unit 407 is an interface used in communications with the operator station building apparatus 203 and the base station apparatus 202b via the fixed communication network 210. The wired I/F unit 407 is connected to the base station radio unit 401, the SIP processing unit 404, the D2D proxy unit 405, the state notification/management unit 406, and the fixed communication network 210.

Each of the terminal apparatuses 201a, 201b has the radio unit 411, the D2D wireless transceiver unit 412, a SIP processing unit 413, and a D2D application 414. The radio unit 411 is a communications unit supporting the LTE-A FDD scheme or TDD scheme, and wirelessly transmits data to and receives data from the base station radio unit 401 of the base station apparatus 202. The radio unit 411 is connected to the SIP processing unit 413 and the D2D application 414.

The D2D wireless transceiver unit 412 transmits data to and receives data from the D2D wireless transceiver unit 403 of the base station apparatus 202 and the D2D wireless transceiver unit 412 of the other terminal apparatus 201 through the D2D communication by the LTE-A scheme. The D2D wireless transceiver unit 412 is connected to the SIP processing unit 413 and the D2D application 414.

The SIP processing unit 413 performs SIP signaling for performing the D2D communication. For example, the SIP processing unit 413 performs the SIP signaling with the SIP AS/HSS 312 of the operator station building apparatus 203. The SIP processing unit 413 is connected to the radio unit 411, the D2D wireless transceiver unit 412, and the D2D application 414.

The D2D application 414 is an application executed in application execution areas of the terminal apparatuses 201a, 201b when the D2D communication is performed. The D2D application 414 is connected to the D2D wireless transceiver unit 412 and the SIP processing unit 413 and can transmit and receive data through the D2D communication. The D2D application 414 can be connected to the radio unit 411 to make up a configuration of directly transmitting data to and receiving data from the base station radio unit 401 of the base station apparatus 202a by the same communication scheme used for D2D communication.

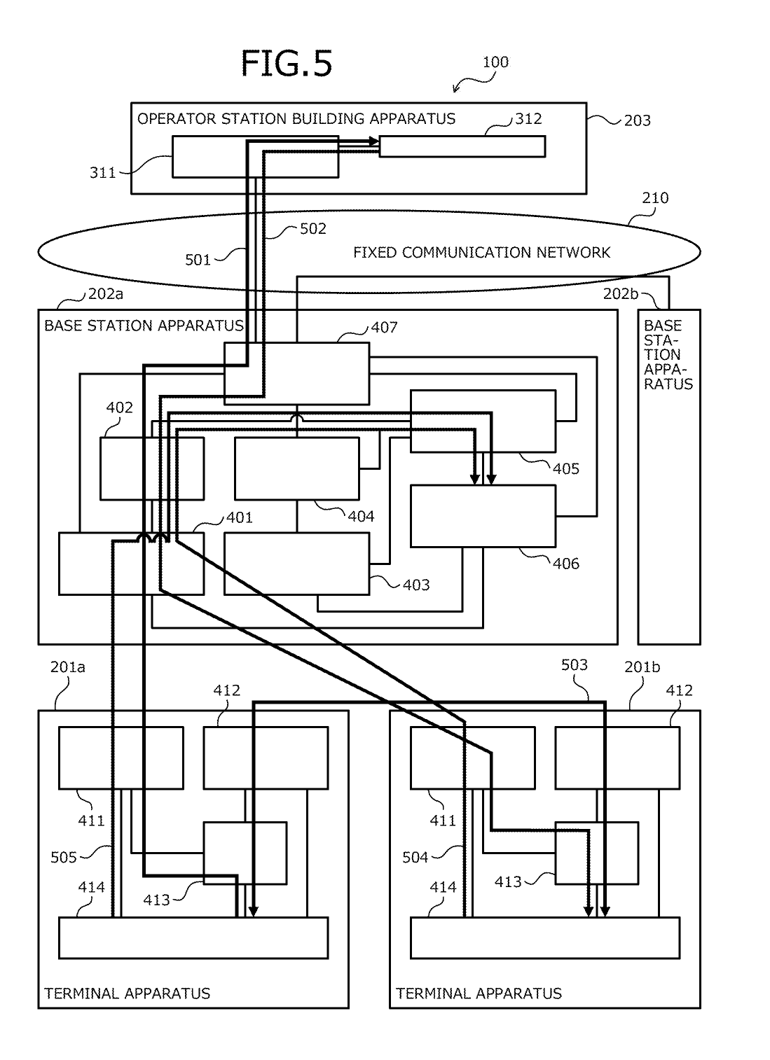

FIG. 5 is an explanatory diagram (part 1) of an example of communication paths in the wireless access system according to the first embodiment. In FIG. 5, the names of the functional units omitted. For example, it is assumed that the D2D application 414 is executed by a user operation to perform the D2D communication at the terminal apparatus 201a. Thus, the terminal apparatus 201a accesses the SIP AS/HSS 312 via the radio unit 411→the base station radio unit 401→the wired I/F 407→the EPC apparatus 311 as indicated by an arrow 501, consequent to a function of the SIP processing unit 413 of the terminal apparatus 201a.

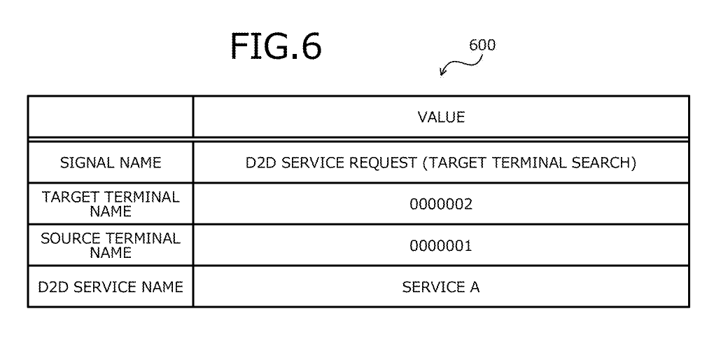

The operator station building apparatus 203 calls the terminal apparatus 201b via the EPC apparatus 311→the wired I/F 407→the base station radio unit 401→the radio unit 411→the SIP processing unit 413 as indicated by an arrow 505. In this case, the base station apparatus 202a transmits to the terminal apparatus 201a and the terminal apparatus 201b, a control signal for establishing the D2D communication. When receiving the control signal from the base station apparatus 202a, the terminal apparatus 201a (transmission source) and the called terminal apparatus 201b transmit and receive search signals (see FIG. 6) using a function of the D2D wireless transceiver units 412, perform handshake, and then establish the D2D communication (D2D bearer) (arrow 503 in FIG. 5).

When the D2D communication is established, the D2D application 414 of the terminal apparatus 201b notifies the state notification/management unit 406 of the usage status of the D2D communication as indicated by arrows 504, 505. For example, the D2D application 414 notifies the state notification/management unit 406 of the usage status of the D2D communication via the radio unit 411→the base station radio unit 401→the traffic off-load unit 402→the D2D proxy unit 405. As a result, when the D2D communication is performed between the terminal apparatus 201a and the terminal apparatus 201b, the base station apparatus 202a can manage the communication time and packet amount by a function of the state notification/management unit 406.

FIG. 6 is an explanatory diagram of an example of a format of the search signal. As depicted in FIG. 6, a format 600 of the search signal includes a signal name, a target terminal name, a source terminal name, and a D2D service name. The signal name is, for example, a name of a signal for searching for the terminal apparatus 201 defined as a target and making a request for a service of the D2D communication. The target terminal name is identification information that indicates the terminal apparatus 201b on the receiving side, for example. The source terminal name is identification information that indicates the terminal apparatus 201a on the transmitting side, for example. The D2D service name indicates the type of service to which the user has subscribed and, for example, the service is associated with higher or lower communication speed depending on a usage fee.

A search signal of the format 600 as described above is transmitted from the terminal apparatus 201a to the terminal apparatus 201b and from the terminal apparatus 201a to the base station apparatuses 202a, 202b. A search signal of the same format 600 is also transmitted from the terminal apparatus 201b to the terminal apparatus 201a and the base station apparatuses 202a, 202b. The terminal apparatus 201 and the base station apparatuses 202a, 202b on the receiving side can detect the intensity of the search signal. Based on the search signals of the format 600 and the reception strength as described above, the terminal apparatus 201a and the terminal apparatus 201b perform the D2D communication.

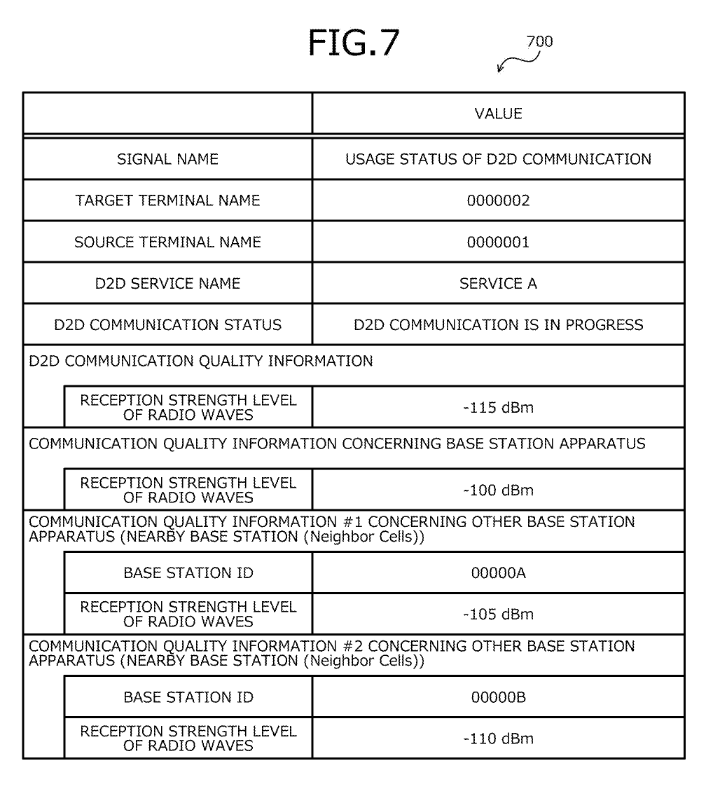

FIG. 7 is an explanatory diagram of an example of a format of the usage status for the D2D communication. As depicted in FIG. 7, a format 700 of the usage status for the D2D communication includes a D2D communication status, D2D communication quality information, communication quality information concerning the base station apparatus 202a, and communication quality information concerning the base station apparatus 202b, in addition to the format 600 depicted in FIG. 6. Usage status in the format 700 is sequentially received from the terminal apparatus 201.

The D2D communication status indicates whether communication is performed as the D2D communication at the terminal apparatus 201a. The D2D communication quality information indicates, for example, the reception strength level of radio waves between the terminal apparatus 201a and the terminal apparatus 201b in the D2D communication between the terminal apparatuses 201a, 201b. The communication quality information for the base station apparatus 202 itself (the base station apparatus 202a) indicates the reception strength level of respective radio waves from the terminal apparatus 201a and the terminal apparatus 201b.

The communication quality information for other base stations (the base station apparatus 202b) indicates base station IDs and reception strength levels of respective radio waves from other base stations 202 received by the terminal apparatus 201a. The base station apparatus 202 can obtain usage status in the format 700 based on signals such as the search signal sequentially received from the terminal apparatuses 201.

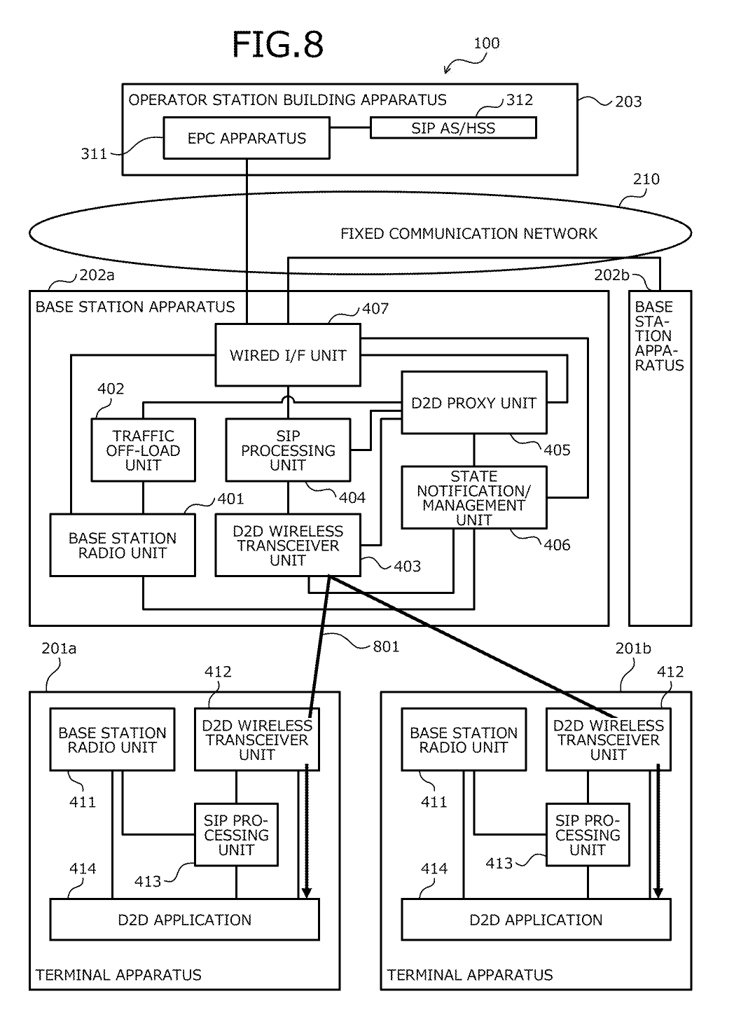

FIG. 8 is an explanatory diagram (part 2) of an example of communication paths in the wireless access system according to the first embodiment. The base station apparatus 202a uses usage status in the format 700 (see FIG. 7) that indicates the usage status of the D2D communication to confirm the wireless communication status of the D2D communication between the two terminal apparatuses 201a, 201b. For example, from the usage statuses of the two terminal apparatuses 201a, 201b received by the state notification/management unit 406, the base station apparatus 202a confirms the D2D communication quality information (reception strength level) and the communication quality information between base stations (the communication quality information concerning the base station apparatus 202a and the communication quality information concerning the other base station (the terminal apparatus 201b)) (see FIG. 7).

If the communication quality is degraded in the D2D communication between the terminal apparatuses 201a, 201b and the communication quality is favorable between the base station apparatus 202a and the two terminal apparatuses 201a, 201b, the D2D communication between the terminal apparatuses 201a, 201b is terminated and switched to the proxy communication with the base station apparatus 202a. In particular, if the terminal apparatus 201b is located outside the D2D communication area 330 (see FIG. 3A) of the terminal apparatus 201a and is located inside the communication area 320a of the base station apparatus 202a, the communication is switched to the proxy communication via the base station apparatus 202a.

For example, the state notification/management unit 406 causes the two terminal apparatuses 201a, 201b to establish communication (bearer) between the D2D wireless transceiver unit 403 and the D2D wireless transceiver unit 412 as indicated by an arrow 801 to switch to the proxy communication via the base station apparatus 202a. As a result, even when the D2D communication can no longer be performed between the terminal apparatus 201a and the terminal apparatus 201b, the proxy communication is performed by the same communication scheme used for the D2D communication and therefore, the communication between the terminal apparatuses 201a, 201b can be performed continuously without dropping the communication.

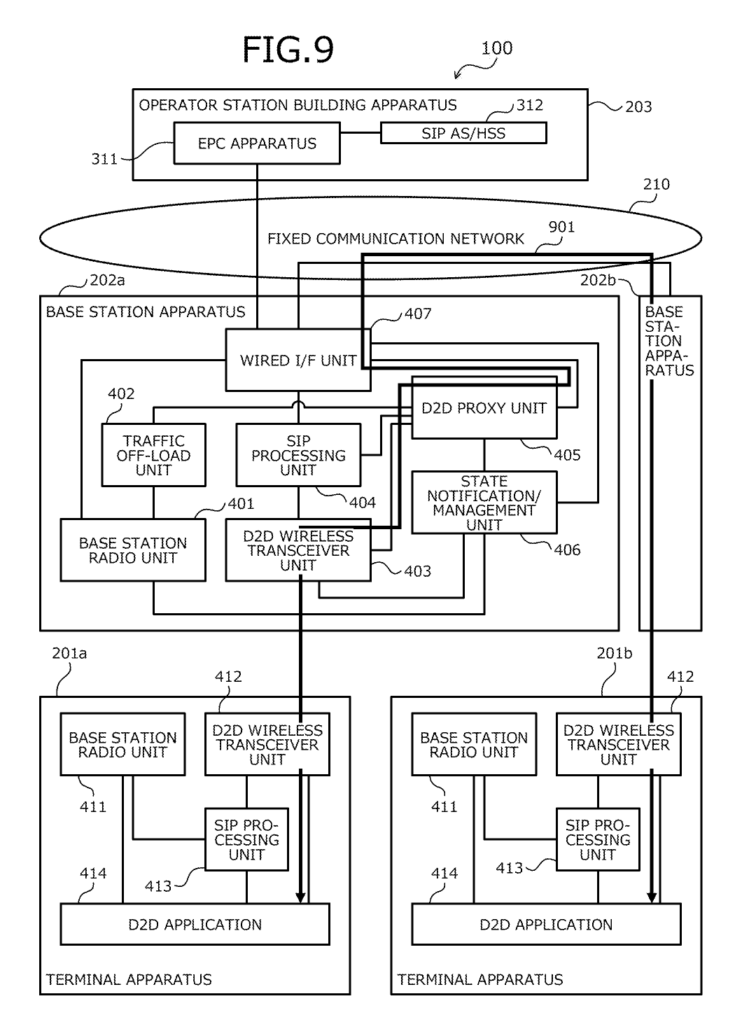

FIG. 9 is an explanatory diagram (part 3) of an example of communication paths in the wireless access system according to the first embodiment. The base station apparatus 202a uses usage status the format 700 (see FIG. 7) that indicates the usage status of the D2D communication to confirm the wireless communication status of the D2D communication between the two terminal apparatuses 201a, 201b.

For example, it is assumed that after switching to the proxy communication via the base station apparatus 202a, the terminal apparatus 201b is then located outside the communication area 320a of the base station apparatus 202a and is located in the communication area 320b of another base station (the base station apparatus 202b) (see FIG. 3B). In this case, the communication is switched to the proxy communication via the other base station (base station apparatus 202b).

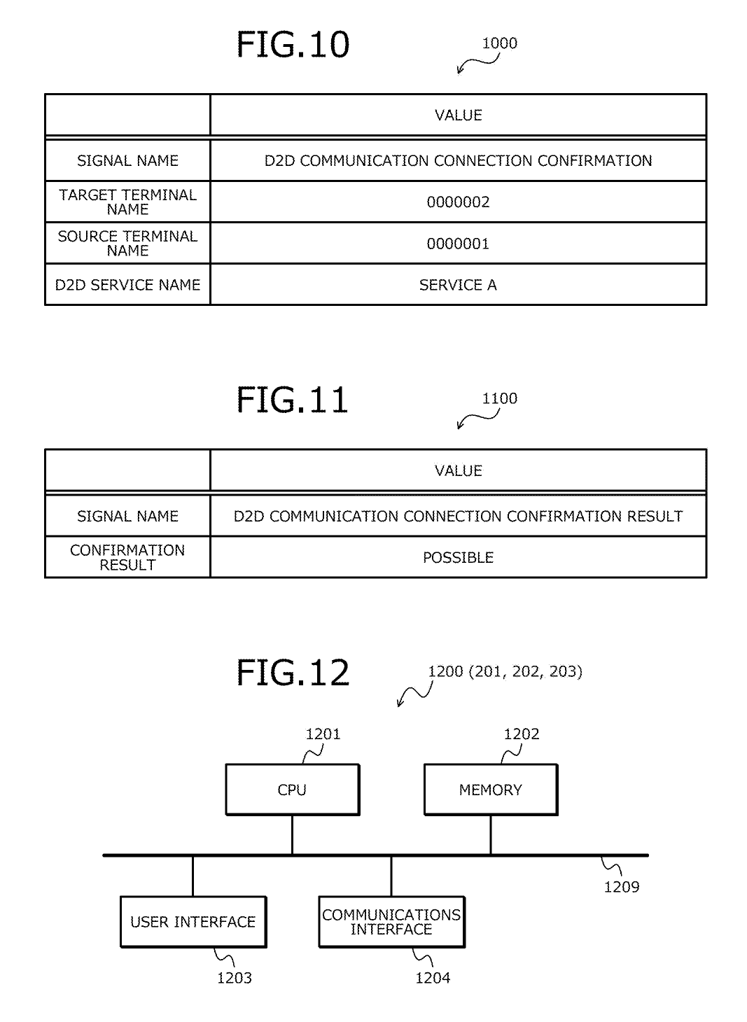

For example, from the usage status of the terminal apparatuses 201a, 201b received by the state notification/management unit 406, the base station apparatus 202a refers to the communication quality status for respect to the base stations (the communication quality information concerning the base station apparatus 202a and the communication quality information concerning other base stations). As a result, if the quality of the communication between the terminal apparatus 201b and the base station apparatus 202a has degraded and the quality of communication with another base station (base station apparatus 202b) is higher, the state notification/management unit 406 uses a predetermined message (see FIG. 10) to confirm whether connection for proxy communication with the base station apparatus 202b is possible.

Subsequently, if the base station apparatus 202b gives notification through a predetermined message (see FIG. 11) that no problem exists in the resource status, etc., the state notification/management unit 406 disconnects the proxy communication provided by the base station apparatus 202a. The state notification/management unit 406 requests the base station apparatus 202b to establish proxy communication with the terminal apparatus 201b. Meanwhile, the communication from the terminal apparatus 201a by the D2D communication with the base station apparatus 202a is continued by the base station apparatus 202a transferring the communication via the D2D wireless transceiver unit 403→the D2D proxy unit 405→the wired I/F unit 407 as indicated by an arrow 901 to the base station apparatus 202b.

As a result, if the D2D communication can no longer be performed between the terminal apparatus 201a and the terminal apparatus 201b or if the communication quality has degraded between the base station apparatus 202a and the terminal apparatus 201b, the proxy communication can also be performed at the base station apparatus 202b. Therefore, if the D2D communication degrades in quality after starting the D2D communication, the communication between the terminal apparatuses 201a, 201b can be performed continuously without dropping the communication. Description will be given of an example of a message for confirming whether another base station (base station apparatus 202b) can be connected for the D2D communication.

FIG. 10 is an explanatory diagram of an example of a message for confirming whether another base station can be connected for the proxy communication. As depicted in FIG. 10, a message 1000 has a signal name, a target terminal name, a source terminal name, and a D2D service name. The signal name is the name of a signal that indicates a connection request for requesting the D2D communication connection. The target terminal name is identification information that indicates the terminal apparatus 201b, for example.

The source terminal name is identification information that indicates the terminal apparatus 201a, for example. The D2D service name indicates the type of service, for example. If the communication quality has degraded between the base station apparatus 202a and the terminal apparatus 201b, the message 1000 is transmitted from the base station apparatus 202a to another base station apparatus (e.g., the base station apparatus 202b).

FIG. 11 is an explanatory diagram of an example of a D2D communication connection response message from another base station. As depicted in FIG. 11, a message 1100 has a signal name and a confirmation result. The signal name is the name of a signal that indicates a confirmation result to be returned as a response concerning a D2D communication request. The confirmation result indicates whether the D2D communication is possible. The message 1100 as described above is transmitted from another base station apparatus (e.g., the base station apparatus 202b) to the base station apparatus 202a.

FIG. 12 is a diagram of an example of a hardware configuration of a computer apparatus. As depicted in FIG. 12, a computer apparatus 1200 such as the terminal apparatus 201, the base station apparatus 202, and the operator station building apparatus 203 includes a central processing unit (CPU) 1201, memory 1202, a user interface 1203, and a communications interface 1204 respectively connected by a bus 1209.

The CPU 1201 provides overall control of the computer apparatus 1200. The memory 1202 includes main memory and auxiliary memory, for example. The main memory is random access memory (RAM), for example. The main memory is used as a work area of the CPU 1201. The auxiliary memory is non-volatile memory such as a magnetic disk, an optical disk, and a flash memory, for example. The auxiliary memory stores various programs causing the computer apparatus 1200 to operate. The programs stored in the auxiliary memory are loaded to the main memory and executed by the CPU 1201.

The user interface 1203 includes, for example, an input device that receives operational input from a user and an output device that outputs information to the user. The input device may be implemented by a touch panel, keys (e.g., a keyboard), or a remote controller, for example. The output device may be implemented by a touch panel, a display, or a speaker, for example. The user interface 1203 is controlled by the CPU 1201.

The communications interface 1204 is, for example, a communications interface that performs wireless or wired communication with an external device. The communications interface 1204 is controlled by the CPU 1201.

For the receiving unit 111, the transmitting unit 112, the obtaining unit 113, the relaying unit 114, the transmitting unit 121, the receiving unit 122, and the control unit 123 depicted in FIG. 1, the functions thereof are implemented by causing the CPU 1201 to execute the programs stored in the memory 1202, or by the user interface 1203. The process results of the functional units are stored to the memory 1202.

For the EPC apparatus 311 and the SIP AS/HSS 312, the traffic off-load unit 402, the SIP processing unit 404, the D2D proxy unit 405, the state notification/management unit 406, the SIP processing unit 413, and the D2D application 414 depicted in FIG. 4, the functions thereof are implemented by causing the CPU 1201 to execute the programs stored in the memory 1202, or by the memory 1202. The base station radio unit 401, the D2D wireless transceiver unit 403, the wired I/F unit 407, the radio unit 411, and the D2D wireless transceiver unit 412 depicted in FIG. 4 are implemented by the communications interface 1204.

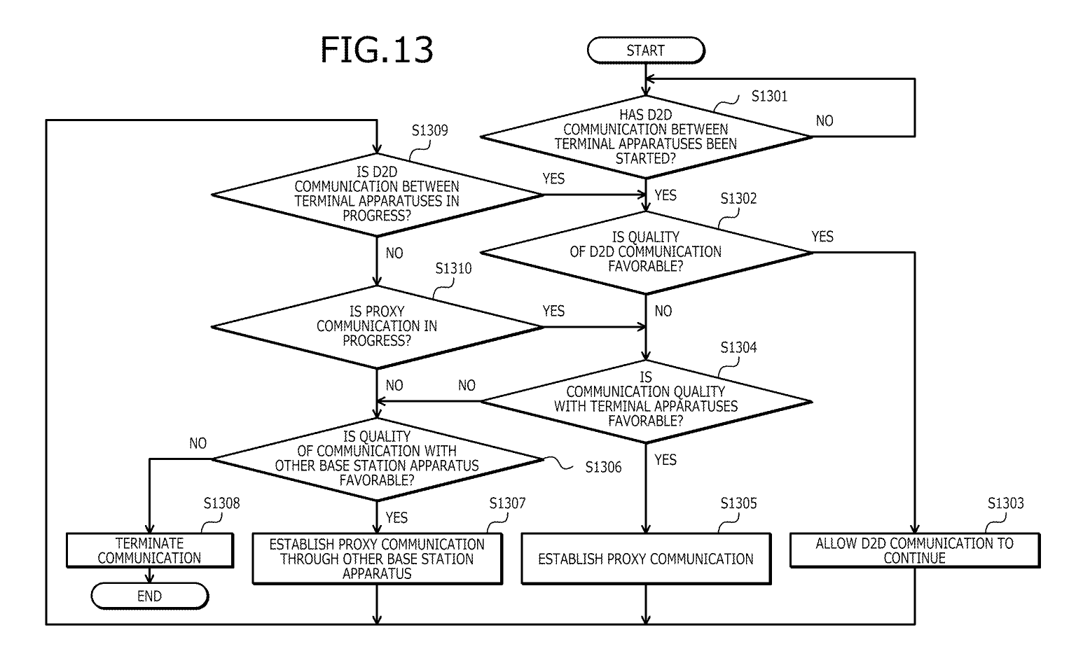

FIG. 13 is a flowchart of an example of an algorithm of a line switching determination based on communication quality. As depicted in FIG. 13, the base station apparatus 202a determines whether D2D communication between the terminal apparatuses 201a, 201b has started (step S1301). The base station apparatus 202a stands by until the D2D communication between the terminal apparatuses 201a, 201b starts (step S1301: NO). When the D2D communication between the terminal apparatuses 201a, 201b has started (step S1301: YES), the base station apparatus 202a determines whether the quality of the D2D communication is favorable (step S1302).

At step S1302, the base station apparatus 202a refers to the D2D communication quality information concerning the format 700 (see FIG. 7) and determines if the reception strength level of radio waves between the terminal apparatus 201a and the terminal apparatus 201b is less than or equal to −100 dBm, for example. If the quality of the D2D communication is favorable (step S1302: YES), the base station apparatus 202a allows the D2D communication to continue (step S1303) and goes to step S1309.

If the quality of the D2D communication is not favorable (step S1302: NO), the base station apparatus 202a determines whether the communication quality is favorable between the base station apparatus 202a and both the terminal apparatuses 201a, 201b (step S1304). At step S1304, for example, the base station apparatus 202a refers to the communication quality information for the base station apparatus 202a in the format 700 (see FIG. 7) to determine if the reception strength levels of radio waves from the terminal apparatuses 201a, 201b are less than or equal to −100 dBm, for example.

If the communication quality is favorable between the base station apparatus 202a and both the terminal apparatuses 201a, 201b (step S1304: YES), the base station apparatus 202a establishes the proxy communication (step S1305) and goes to step S1309. The proxy communication is performed via the base station apparatus 202a by the same communication scheme used for the D2D communication. If the quality is not favorable between the base station apparatus 202a and either the terminal apparatus 201a or 201b (step S1304: NO), the base station apparatus 202a determines whether the quality of the communication with the base station apparatus 202b is favorable (step S1306).

At step S1306, for example, it is determined whether the communication quality is favorable between the terminal apparatus 201 with which the communication quality is unfavorable and the base station apparatus 202b. For example, the base station apparatus 202a refers to the communication quality information concerning the base station apparatus 202b in the format 700 (see FIG. 7) to determine if the reception strength level at the base station apparatus 202b is less than or equal to −100 dBm for the radio waves of each of the terminal apparatuses 201a, 201b. If the communication quality is favorable between the terminal apparatus 201 and the base station apparatus 202b (step S1306: YES), the base station apparatus 202a establishes the proxy communication through the base station apparatus 202b by the same communication scheme used for D2D communication (step S1307) and goes to step S1309.

If the communication quality is not favorable between the terminal apparatus 201 and the base station apparatus 202b (step S1306: NO), the base station apparatus 202a terminates the communication (step S1308) and terminates a series of operations of the flowchart. At step S1309, the base station apparatus 202a determines whether the D2D communication between the terminal apparatuses 201a, 201b is in progress (step S1309).

If the D2D communication between the terminal apparatuses 201a, 201b is in progress (step S1309: YES), the base station apparatus 202a goes to step S1302. If the D2D communication between the terminal apparatuses 201a, 201b is not in progress (step S1309: NO), the base station apparatus 202a determines whether proxy communication through the base station apparatus 202a is in progress (step S1310). If proxy communication through the base station apparatus 202a is in progress (step S1310: YES), the base station apparatus 202a goes to step S1304. If proxy communication through the base station apparatus 202a is not in progress (step S1310: NO), i.e., if proxy communication through the base station apparatus 202b is in progress, the base station apparatus 202a goes to step S1306.

Although the operations described above include a transition from the proxy communication through the base station apparatus 202a to the proxy communication through the base station apparatus 202b, for example, if the quality of the communication through the base station apparatus 202a is recovered, a transition may be made from the proxy communication through the base station apparatus 202b to the proxy communication through the base station apparatus 202a. For example, a step of determining “whether the quality of communication with the base station apparatus 202a is favorable” is inserted immediately before step S1308 and the base station apparatus 202a may go to step S1305 if favorable or go to step S1308 if not favorable. If the communication quality is recovered between the terminal apparatuses 201a, 201b, the D2D communication between the terminal apparatuses 201a, 201b may be resumed.

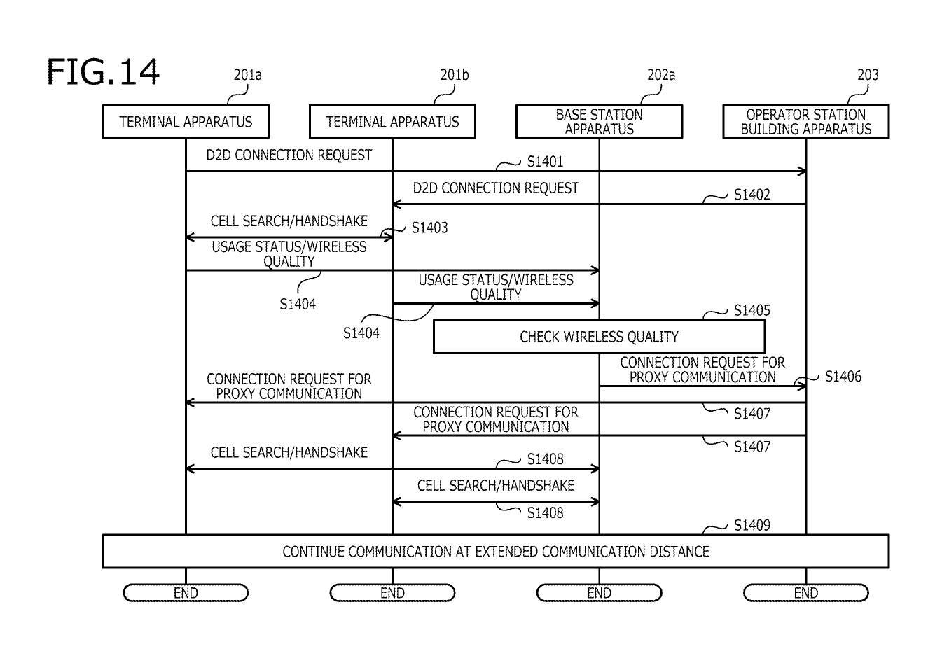

FIG. 14 is a sequence diagram of an example of an operation of starting the D2D communication between the terminal apparatuses and switching the D2D communication between the terminal apparatuses to the communication through the base station apparatus 202a. As depicted in FIG. 14, for example, the terminal apparatus 201a makes a connection request for D2D communication to the operator station building apparatus 203 via the base station apparatus 202a (step S1401).

In response, the operator station building apparatus 203 makes a D2D connection request to the terminal apparatus 201b (step S1402). In this case, the base station apparatus 202a transmits a control signal for establishing the D2D communication to the terminal apparatus 201a and the terminal apparatus 201b. The terminal apparatus 201a and the terminal apparatus 201b mutually perform a cell search and handshake according to the search signal of the format 600 (see FIG. 6) (step S1403) to establish the D2D communication. Subsequently, the terminal apparatus 201a and the terminal apparatus 201b each notify the base station apparatus 202a of usage status and wireless quality (step S1404).

The base station apparatus 202a uses the received usage status and wireless quality to obtain the format 700 (see FIG. 7) to check the wireless quality (step S1405). If the quality of the D2D communication has degraded, the base station apparatus 202a makes a connection request to the operator station building apparatus 203 for proxy communication via the base station apparatus 202a by the same communication scheme used for D2D communication (step S1406).

When receiving the connection request, the operator station building apparatus 203 makes a connection request for the proxy communication to the terminal apparatus 201a and the terminal apparatus 201b (step S1407). Subsequently, a cell search and handshake are performed between the terminal apparatus 201a and the base station apparatus 202a as well as between the terminal apparatus 201b and the base station apparatus 202a (step S1408).

If the communication quality is favorable between the terminal apparatus 201a and the base station apparatus 202a and between the terminal apparatus 201b and the base station apparatus 202a, the wireless access system 100 establishes the proxy communication and continues the communication at an extended communication distance (step S1409). As described above, even when the D2D communication can no longer be performed between the terminal apparatus 201a and the terminal apparatus 201b, the proxy communication is performed by the same communication scheme used for D2D communication and therefore, the communication between the terminal apparatuses 201a, 201b can be performed continuously without dropping the communication.

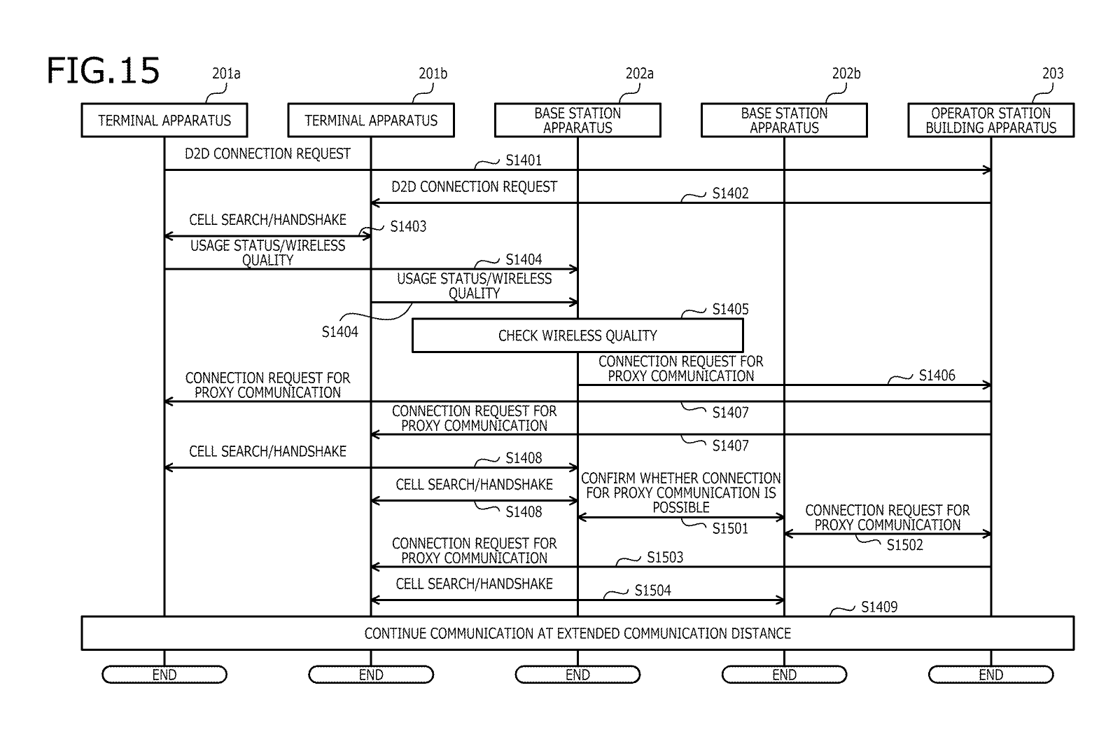

FIG. 15 is a sequence diagram of an example of an operation of starting the D2D communication between the terminal apparatuses and switching the D2D communication between the terminal apparatuses to the proxy communication through another base station apparatus. In the description of FIG. 15, the portions identical to those described with reference to FIG. 14 are denoted by the same reference numerals used in FIG. 14 and will not be described.

The cell search and the handshake at step S1408 depicted in FIG. 15 may indicate that the communication quality has degraded between the base station apparatus 202a and either of the terminal apparatuses 201a, 201b (e.g., terminal apparatus 201b) whereby the proxy communication cannot be performed with the affected terminal apparatus. In this case, the base station apparatus 202a uses the message 1000 to confirm whether the base station apparatus 202b can be connected to the terminal apparatus 201b for the proxy communication (step S1501).

The base station apparatus 202b refers to the usage status in the format 700 and, if the proxy communication can be performed, the base station apparatus 202b makes a connection request for proxy communication through the base station apparatus 202b, to the operator station building apparatus 203 (step S1502). In response, the operator station building apparatus 203 makes a proxy communication connection request to the terminal apparatus 201b (step S1503). Subsequently, the terminal apparatus 201b and the base station apparatus 202b mutually perform a cell search and handshake (step S1504).

The wireless access system 100 establishes the proxy communication through the base station apparatus 202a and the proxy communication through the base station apparatus 202b, and continues the communication at an extended communication distance (step S1409). As described above, even when one of the terminal apparatuses 201 is located outside the communication area of its own base station (e.g., the base station of the base station apparatus 202a) and the proxy communication through its own base station (e.g., the base station of the base station apparatus 202a) cannot be performed, proxy communication through another base station (e.g., the base station of the base station apparatus 202b) is performed and therefore, the communication between the terminal apparatuses 201 can be performed continuously without dropping the communication.

According to the first embodiment, the communication between the terminal apparatus 201a and the terminal apparatus 201b using the communication scheme for the D2D communication can be stabilized and the other frequency bands can be prevented from being pressured, enabling efficient frequency band use.

The second embodiment will be described. In a configuration described in the second embodiment, if the base station apparatus 202a has an available communication line while the D2D communication between the terminal apparatuses 201 is performed, the proxy communication through the base station apparatus 202a and communication with a base station are performed. In the following description, the details described in the first embodiment are denoted by the same reference numerals used in the first embodiment and will not be described

An overview of the second embodiment will be described with reference to FIG. 1. The relaying unit 114 depicted in FIG. 1 concurrently uses a first line and a second line to relay the communication between the first terminal apparatus 120a and the second terminal apparatus 120b. The first line is formed by wirelessly communicating by a predetermined communication scheme with each of the first terminal apparatus 120a and the second terminal apparatus 120b. The predetermined communication scheme is the communication scheme for the D2D communication.

The second line is formed by wirelessly communicating with each of the first terminal apparatus 120a and the second terminal apparatus 120b by a communication scheme that differs from the predetermined communication scheme. The communication scheme is a communication scheme for communication with a base station such as RRC. The base station apparatus 110 can use the first line and the second line at the same time independently of each other or can use the first line and the second line at the same time in a combined manner, for example. The relay of communication by using the first line and the second line at the same time is a relay through carrier aggregation, for example.

For example, the obtaining unit 113 obtains information that indicates the availability of a line for performing communication (the proxy communication) with each of the first terminal apparatus 120a and the second terminal apparatus 120b in the same predetermined communication scheme as the direct wireless communication. The information that indicates the availability of a line is information concerning a count of available lines, for example.

Based on the information obtained by the obtaining unit 113, the relaying unit 114 relays the communication between the first terminal apparatus 120a and the second terminal apparatus 120b if respective lines are available. In this case, the relaying unit 114 wirelessly communicates by the predetermined communication scheme with each of the first terminal apparatus 120a and the second terminal apparatus 120b.

As a result, when lines are available, the direct wireless communication can be switched to the proxy communication regardless of the wireless propagation quality between the first terminal apparatus 120a and the second terminal apparatus 120b. Therefore, the communication can be performed with higher quality as compared to the direct wireless communication.

The obtaining unit 113 also obtains information that indicates the availability of a line for performing communication with each of the first terminal apparatus 120a and the second terminal apparatus 120b in a communication scheme different from the predetermined communication scheme. Based on the information obtained by the obtaining unit 113, the relaying unit 114 relays the communication by using multiple (two) lines at the same time if the following condition is satisfied.

The condition is the presence of available lines for performing the communication by the predetermined communication scheme and the presence of available lines for performing the communication by the communication scheme different from the predetermined communication scheme. For example, the condition is that two lines corresponding to the first terminal apparatus 120a and the second terminal apparatus 120b are available for each of the communication schemes.

One line of the two lines is the first line for relaying the communication between the first terminal apparatus 120a and the second terminal apparatus 120b through wireless communication by the predetermined communication scheme with each of the first terminal apparatus 120a and the second terminal apparatus 120b.

The other line is the second line for relaying the communication between the first terminal apparatus 120a and the second terminal apparatus 120b through wireless communication with each of the first terminal apparatus 120a and the second terminal apparatus 120b by the communication scheme different from the predetermined communication scheme.

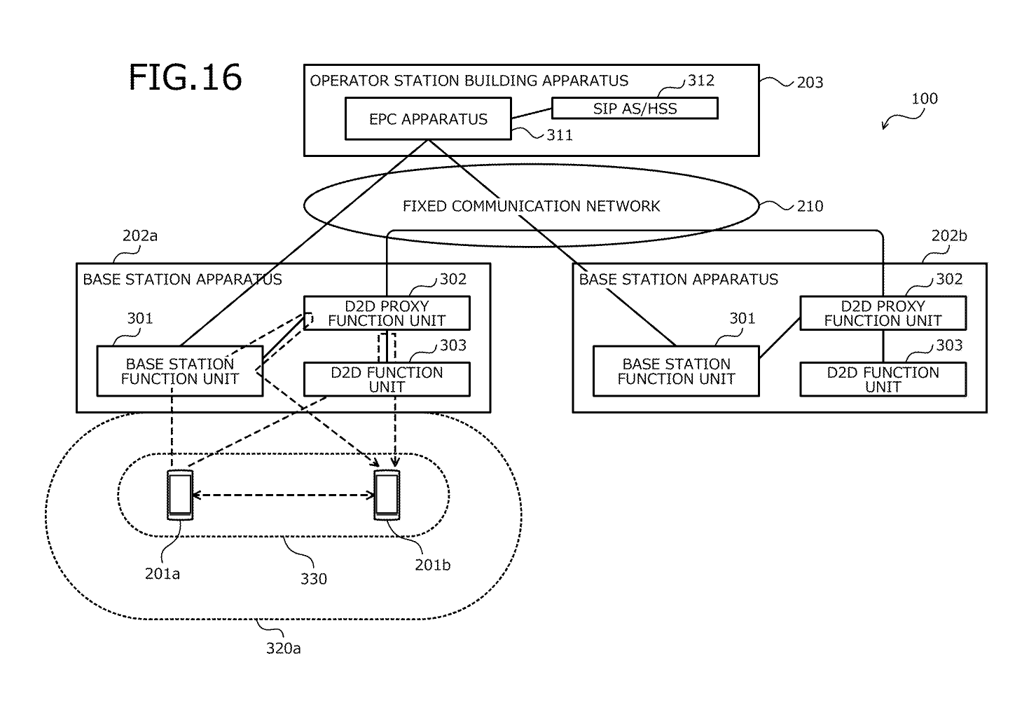

FIG. 16 is an explanatory diagram of an overview of communication in the wireless access system of the second embodiment. In FIG. 16, it is assumed that the terminal apparatuses 201a, 201b perform the D2D communication in the communication area 320a of the base station apparatus 202a.

In this state, it is assumed that the base station apparatus 202a has two or more available lines for performing at the base station function unit 301, the communication with a base station, and two or more available lines for the proxy communication at the D2D function unit 303. This means that for each type of line, two respective lines for the terminal apparatus 201a and the terminal apparatus 201b exist. In this case, the terminal apparatus 201a and the terminal apparatus 201b each establish a new communication through the base station apparatus 202a. As a result, a broadband communication can be performed by combining two communications, i.e., the communication with a base station via the base station function unit 301 and the proxy communication via the D2D function unit 303.

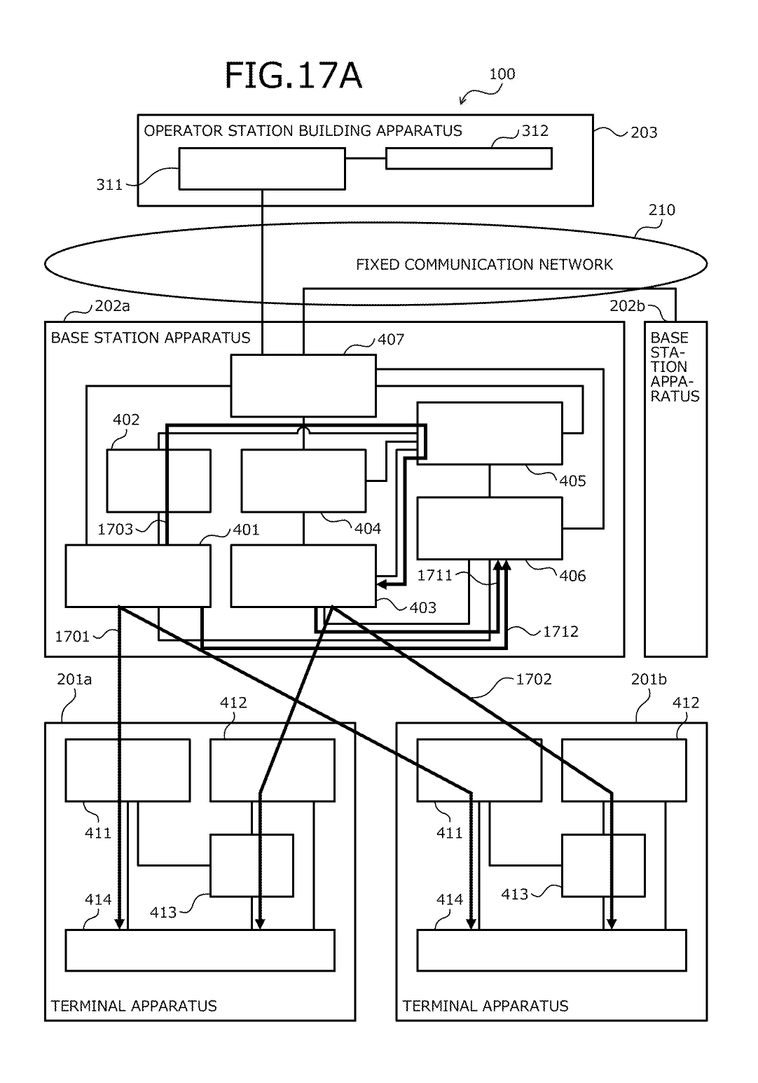

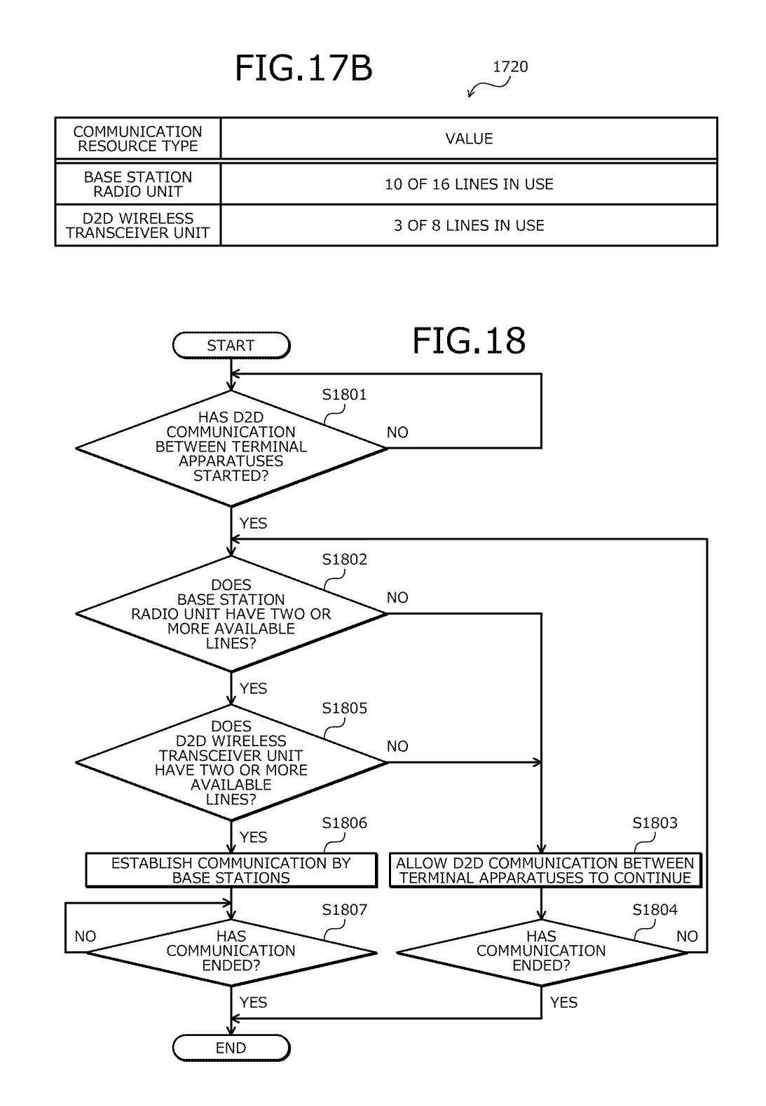

FIG. 17A is an explanatory diagram of an example of communication paths in the wireless access system according to the second embodiment. In FIG. 17A, the names of the functional units are omitted. The D2D communication is assumed to be established between the terminal apparatus 201a and the terminal apparatus 201b through the procedure depicted in FIG. 5. In this state, the base station apparatus 202a confirms the resource status to determine whether both the communication with a base station and the D2D communication can be established.

The state notification/management unit 406 sequentially obtains a communication resource status (see FIG. 17B) from the base station radio unit 401 and the D2D wireless transceiver unit 403 (see arrow 1711 and arrow 1712). The state notification/management unit 406 determines whether a resource is available at each of the base station radio unit 401 and the D2D wireless transceiver unit 403. The communication resource status is, for example, a value from which the number of remaining available lines can be obtained, and is, for example, the maximum number of available lines and the number of lines currently in use. An available resource means that two or more available lines exist, for example.

If an available resource exists, the base station apparatus 202a establishes communication with a base station and the D2D communication at the same time. The D2D proxy unit 405 can combine the respective communications to form a broadband communication.

For example, the state notification/management unit 406 establishes two communications with the two terminal apparatuses 201a, 201b. The two communications are the communication with a base station (bearer) between the base station radio unit 401 and the radio unit 411 indicated by an arrow 1701 and the D2D communication between the D2D wireless transceiver unit 403 and the D2D wireless transceiver unit 412 indicated by an arrow 1702.

A signal of the communication with a base station is transmitted as indicated by arrow 1703 through a path of the traffic off-load unit 402→the D2D proxy unit 405→the D2D wireless transceiver unit 403. As a result, the two terminal apparatuses 201a, 201b can communicate through the broadband communication obtained by combining the two communications, i.e., the communication with a base station and the D2D communication.

FIG. 17B is an explanatory diagram of an example of a format of the resource status. As depicted in FIG. 17B, a format 1720 of the resource status includes a communication resource type and a value. The communication resource type indicates the base station radio unit 401 or the D2D wireless transceiver unit 403. The value is a value from which the number of remaining available lines can be obtained, and is, for example, the maximum number of available lines and the number of lines currently used. The base station apparatus 202a can establishes the two communications, i.e., the communication with a base station and the proxy communication, if two or more available lines are confirmed to respectively exist by referring to the resource status of the format 1720 as described above.

FIG. 18 is a flowchart of an example of an algorithm of line establishment based on an available resource. As depicted in FIG. 18, the base station apparatus 202a determines whether the D2D communication between the terminal apparatuses 201a, 201b has started (step S1801). The base station apparatus 202a stands by until the D2D communication between the terminal apparatuses 201a, 201b is started (step S1801: NO). When the D2D communication between the terminal apparatuses 201a, 201b has started (step S1801: YES), the base station apparatus 202a determines if the base station radio unit 401 has two or more available lines (step S1802).

If the base station radio unit 401 does not have two or more available lines (step S1802: NO), the base station apparatus 202a allows the D2D communication between the terminal apparatuses 201a, 201b to continue (step S1803). The base station apparatus 202a then determines whether the D2D communication between the terminal apparatuses 201a, 201b has ended (step S1804).

If the D2D communication has not ended (step S1804: NO), the base station apparatus 202a goes to step S1802. If the D2D communication has ended (step S1804: YES), the base station apparatus 202a terminates a series of operations of the flowchart. If the base station radio unit 401 has two or more available lines at step S1802 (step S1802: YES), the base station apparatus 202a determines if the D2D wireless transceiver unit 403 has two or more available lines (step S1805).

If the D2D wireless transceiver unit 403 does not have two or more available lines (step S1805: NO), the base station apparatus 202a goes to step S1803. If the D2D wireless transceiver unit 403 has two or more available lines (step S1805: YES), the base station apparatus 202a establishes two communications, the communication with a base station and the D2D communication (step S1806). It is noted that even when the D2D wireless transceiver unit 403 has two or more available lines, the D2D communication between the terminal apparatuses 201a, 201b may be continued depending on, for example, the name of the D2D service to which a user has subscribed (see the format 700 in FIG. 7). The base station apparatus 202a then determines whether the communications have ended (step S1807).

The base station apparatus 202a stands by until the communications have ended (step S1807: NO) and terminates a series of operations of the flowchart when the communications have ended (step S1807: YES). It is noted that even when the base station radio unit 401 does not have two or more lines as an available resource, the proxy communication may be performed if the quality is degraded in the D2D communication between the terminal apparatuses 201a, 201b and the D2D wireless transceiver unit 403 has two or more lines as an available resource.

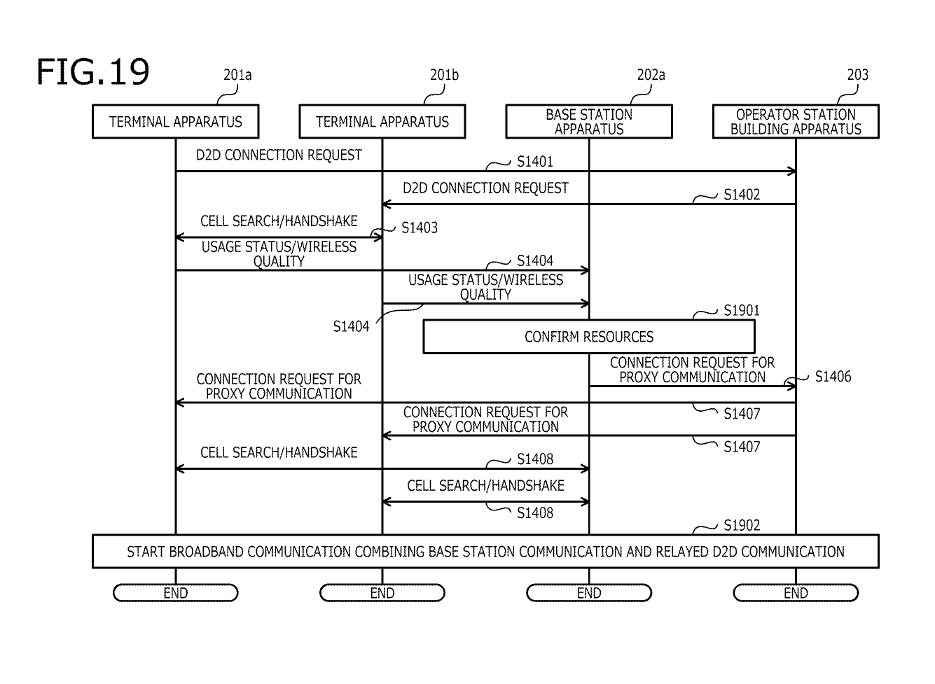

FIG. 19 is a sequence diagram of an example of an operation of starting the D2D communication between the terminal apparatuses and establishing the two communications including the communication with a base station and the D2D communication. As depicted in FIG. 19, the D2D communication is established by the operations at steps S1401 to S1404. When the D2D communication is established, the base station apparatus 202a confirms the available resources (step S1901). If the base station radio unit 401 and the D2D wireless transceiver unit 403 each have two or more available lines, the base station apparatus 202a makes a connection request for performing the proxy communication via the base station apparatus 202a (step S1406).

Subsequently, the operations at steps S1407 to S1408 described above are executed to start the broadband communication obtained by combining the two communications including the communication with a base station via the base station function unit 301 and the proxy communication via the D2D function unit 303 (step S1902).

According to the second embodiment, since the broadband communication can be performed by combining the two communications, i.e., the communication with a base station and the proxy communication, the communication speed can be improved.

The third embodiment will be described. In a configuration described in the third embodiment, the terminal apparatus 201a and the terminal apparatus 201b are away from each other to the extent that the D2D communication cannot be performed, and the proxy communication is started via the base station apparatus 202a or the base station apparatus 202b. In particular, description will be made of a configuration that starts the proxy communication when the terminal apparatus 201a and the terminal apparatus 201b are away from each other to an extent that respective search signals are not mutually received.

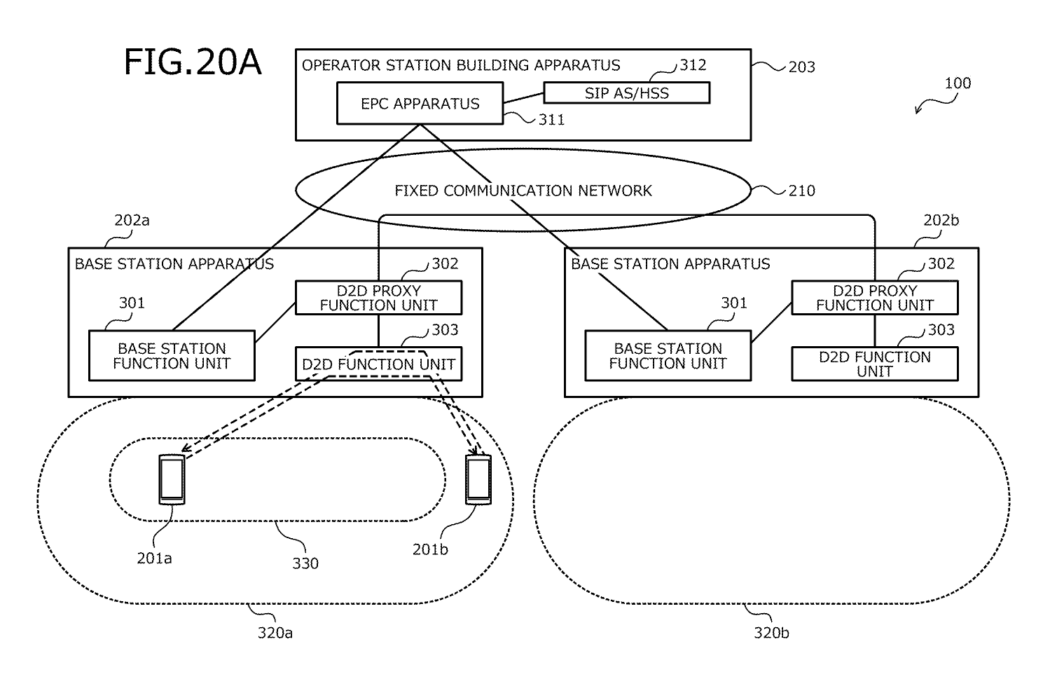

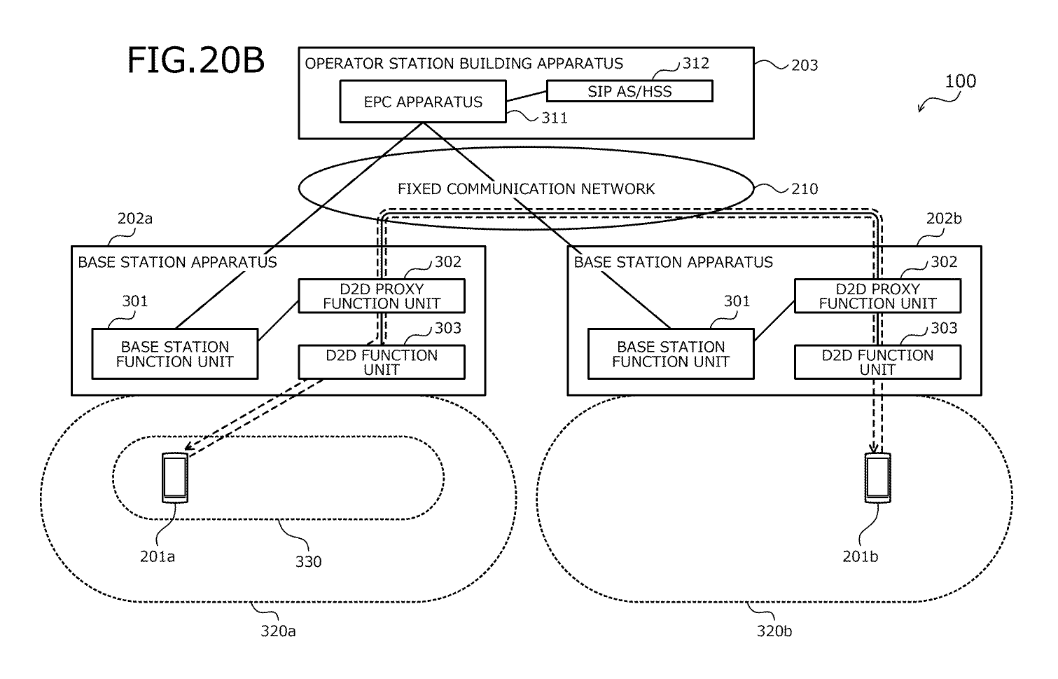

FIG. 20A is an explanatory diagram (part 1) of an overview of communication in the wireless access system according to the third embodiment. In FIG. 20A, both the terminal apparatus 201a and the terminal apparatus 201b are located in the communication area 320a of the base station apparatus 202a. Additionally, the terminal apparatus 201b is located outside the D2D communication area 330 of the terminal apparatus 201a. In this state, the terminal apparatus 201a and the terminal apparatus 201b cannot send a search signal to each other and cannot perform the D2D communication. Therefore, the base station apparatus 202a performs the proxy communication so that the terminal apparatus 201a and the terminal apparatus 201b can perform communication by the same communication scheme used for the D2D communication.

FIG. 20B is an explanatory diagram (part 2) of an overview of communication in the wireless access system according to the third embodiment. In FIG. 20B, the terminal apparatus 201a is located in the communication area 320a of the base station apparatus 202a. The terminal apparatus 201b is located in the communication area 320b of the base station apparatus 202b. Also in this state, as is the case in FIG. 20A, the terminal apparatus 201a and the terminal apparatus 201b cannot send a search signal to each other and cannot perform the D2D communication. Therefore, the base station apparatuses 202a, 202b perform the proxy communication so that the terminal apparatus 201a and the terminal apparatus 201b can perform communication by the same communication scheme used for D2D communication.

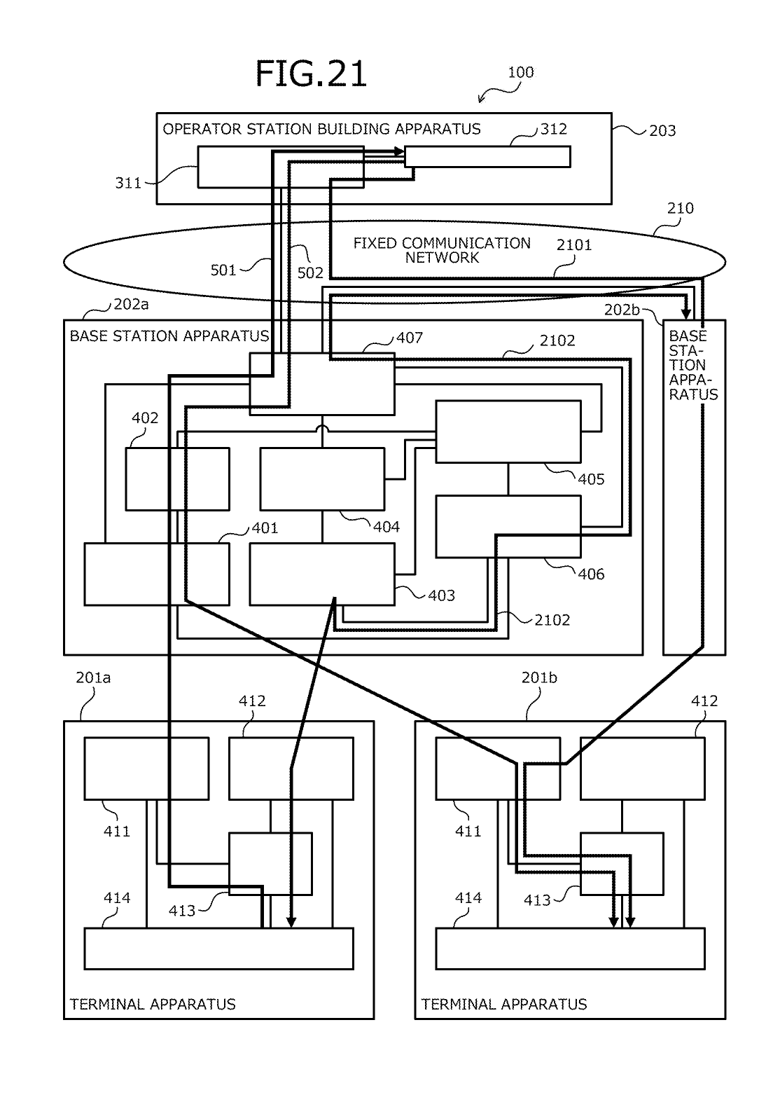

FIG. 21 is an explanatory diagram of an example of communication paths in the wireless access system according to the third embodiment. In FIG. 21, the names of the functional units are omitted. It is assumed that the D2D application 414 is executed by a user operation at the terminal apparatus 201a. As a result, the terminal apparatus 201a accesses the SIP AS/HSS 312 via the radio unit 411→the base station radio unit 401→the wired I/F 407→the EPC apparatus 311 as indicated by an arrow 501, by a function of the SIP processing unit 413 of the terminal apparatus 201a.

If the terminal apparatus 201b is located in the communication area of the base station of the base station apparatus 202a, the operator station building apparatus 203 calls the terminal apparatus 201b through the EPC apparatus 311→the wired I/F 407→the base station radio unit 401→the radio unit 411→the SIP processing unit 413 as indicted by an arrow 502. The base station apparatus 202a transmits search signals to and receives search signals (see FIG. 6) from the terminal apparatuses 201a, 201b by a function of the D2D wireless transceiver unit 412.

The search signals include a target terminal name, a source terminal name, D2D service contents, etc. The target terminal name and the source terminal name are unique IDs such as International Mobile Subscriber Identity (IMSI), for example. When receiving the search signals, the base station apparatus 202a confirms a relation between the terminal apparatus 201a and the terminal apparatus 201b in the communication area 320a. For example, the state notification/management unit 406 refers to the information concerning each of the search signals received in the communication area of the base station of the base station apparatus 202a to confirm whether the relations of the target terminal name and the source terminal name match each other and if so, the proxy communication is established.

For example, if the relations of the target terminal name and the source terminal name match each other, the proxy communication is established between the terminal apparatus 201a and the terminal apparatus 201b. For example, the state notification/management unit 406 provides control of establishing communication (bearer) between the D2D wireless transceiver unit 403 and the D2D wireless transceiver unit 412 for each of the terminal apparatuses 201a and 201b, thereby establishing the proxy communication.

As indicted by arrow 801 in FIG. 8, the state notification/management unit 406 establishes communication (bearer) between the D2D wireless transceiver unit 403 and the D2D wireless transceiver unit 412 for the two terminal apparatuses 201a, 201b and the proxy communication via the base station apparatus 202a is performed. As a result, the communication distance can be extended by the proxy communication at the base station apparatus 202a, to establish communication between the two terminal apparatuses 201a, 201b that are away from each other to an extent that the D2D communication cannot be performed.

If the terminal apparatus 201b is located in the communication area of the base station of the base station apparatus 202b, the operator station building apparatus 203 calls the terminal apparatus 201b through the EPC apparatus 311→the wired I/F and the base station radio unit of the base station apparatus 202b→the radio unit 411→the SIP processing unit 413 as indicated by arrow 2101. The terminal apparatus 201a (the transmission source) and the called terminal apparatus 201b transmit and receive search signals (see FIG. 6) by a function of the D2D wireless transceiver units 412 of the terminal apparatuses 201a, 201b.

The search signals are received by the base station apparatus 202a and the base station apparatus 202b. The base station apparatus 202a and the base station apparatus 202b transfer the received search signals to each other. For example, as indicated by arrow 2102, the base station apparatus 202a receives the search signal from the terminal apparatus 201a by the D2D wireless transceiver unit 403.

After the search signal is received by the D2D wireless transceiver unit 403, the state notification/management unit 406 transmits search information via the wired I/F unit 407 to other base stations (e.g., the base station apparatus 202b). The other base stations are, for example, all the other base stations according to a list specified in advance, other nearby base stations that are automatically detected, other base stations of the LTE standard, etc.

The base station apparatus 202a receives the search signals from the other base stations and confirms the relations with D2D terminals in the communication areas. For example, the state notification/management unit 406 receives via the wired I/F unit 407, the search information (such as the target terminal name, the source terminal name, the D2D service contents) transmitted from the other base stations.

The state notification/management unit 406 refers to the search signals received from the other base stations and the information concerning the search signal received in the communication area of the base station of the base station apparatus 202a to confirm whether the relations of the target terminal name and the source terminal name match each other. If the relations match, the state notification/management unit 406 notifies the base station that is the transmission source of the received search signal to establish the proxy communication.

If the relations match, the proxy communication is established between the terminal apparatus 201b in the communication area of the other base station and the terminal apparatus 201a in the communication area of the base station of the base station apparatus 202a. For example, the state notification/management unit 406 provides control of establishing communication (bearer) between the D2D wireless transceiver unit 403 and the D2D wireless transceiver unit 412 for the terminal apparatus 201a, thereby establishing the proxy communication via the base station apparatus 202a. Similarly, the base station apparatus 202b establishes the proxy communication with the terminal apparatus 201b.

The communication contents from the terminal apparatus 201b performing the proxy communication with the other base station are transferred to the base station of the base station apparatus 202a via the wired I/F unit 407→the D2D proxy unit 405→the D2D wireless transceiver unit 403 as indicted by arrow 901 in FIG. 9 so as to perform the communication. Therefore, the communication distance can be extended by the proxy communication to establish the communication between the terminal apparatuses 201a, 201b that are away from each other to an extent that the D2D communication cannot be performed.

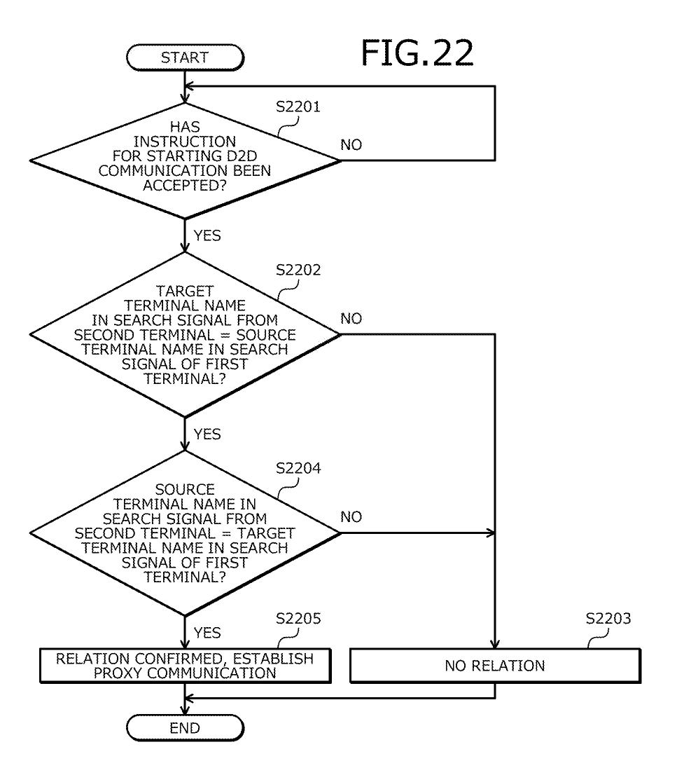

FIG. 22 is a flowchart of an example of an algorithm of referring to a search signal. As depicted in FIG. 22, the base station apparatus 202a determines whether an instruction for starting the D2D communication has been accepted by the terminal apparatus 201a (step S2201). Whether an instruction for starting the D2D communication is accepted means, for example, whether the D2D application 414 has been executed.

The base station apparatus 202a stands by until an instruction for starting the D2D communication is accepted (step S2201: NO). When an instruction for starting the D2D communication has been accepted (step S2201: YES), the base station apparatus 202a refers to search signals to determine whether the target terminal name in the search signal from a second terminal is the source terminal name in the search signal at a first terminal (step S2202). The first terminal is one terminal (e.g., the terminal apparatus 201a) used as the basis for referring to the search signals, for example. The second terminal is another terminal (e.g., the terminal apparatus 201b) compared with the first terminal, for example.

If the target terminal name in the search signal from the second terminal is not the source terminal name in the search signal for the first terminal (step S2202: NO), the relation is not established (step S2203) and a series of operations of the flowchart is directly terminated. If the target terminal name in the search signal from the second terminal is the source terminal name in the search signal for the first terminal (step S2202: YES), the base station apparatus 202a determines whether the source terminal name in the search signal from the second terminal is the target terminal name in the search signal for the first terminal (step S2204).

If the source terminal name in the search signal from the second terminal is not the target terminal name in the search signal for the first terminal (step S2204: NO), the base station apparatus 202a goes to step S2203. If the source terminal name in the search signal from the second terminal is the target terminal name in the search signal for the first terminal (step S2204: YES), the relation is confirmed and the base station apparatus 202a establishes the proxy communication (step S2205) and terminates a series of operations of the flowchart.

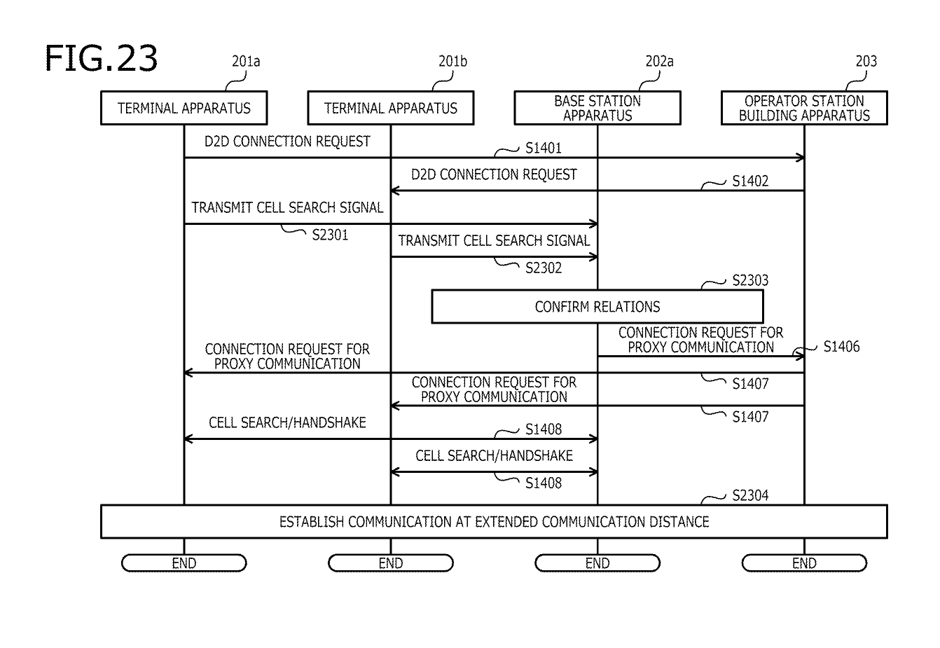

FIG. 23 is a sequence diagram of an example of an operation of starting the proxy communication at the base station of the base station apparatus 202a. As depicted in FIG. 23, the terminal apparatus 201a makes a connection request for the D2D communication via the base station apparatus 202a to the operator station building apparatus 203 (step S1401). In response, the operator station building apparatus 203 makes a D2D connection request to the terminal apparatus 201b (step S1402). In this case, for example, the base station apparatus 202a transmits to the terminal apparatus 201a and the terminal apparatus 201b, a control signal for establishing the D2D communication.

The terminal apparatus 201a transmits a cell search signal to the base station apparatus 202a (step S2301). For example, the base station apparatus 202a intercepts the cell search signal transmitted from the terminal apparatus 201a. The terminal apparatus 201b transmits a cell search signal to the base station apparatus 202a (step S2302). For example, the base station apparatus 202a intercepts the cell search signal transmitted from the terminal apparatus 201b. The terminal apparatus 201a and the terminal apparatus 201b are away from each other and cannot receive the each other's cell search signals.

The base station apparatus 202a refers to the cell search signals to confirm the relations between the target terminal name and the source terminal name (step S2303). If the relations between the target terminal name and the source terminal name match each other, the base station apparatus 202a makes a connection request for the proxy communication, to the operator station building apparatus 203 (step S1406).

Subsequently, steps S1407 to S1408 described above are executed to perform the proxy communication at the base station of the base station apparatus 202a and establish communication at an extended communication distance (step S2304). As described above, even when the D2D communication cannot be started between the terminal apparatus 201a and the terminal apparatus 201b, the proxy communication can be started by the same communication scheme used for D2D communication.

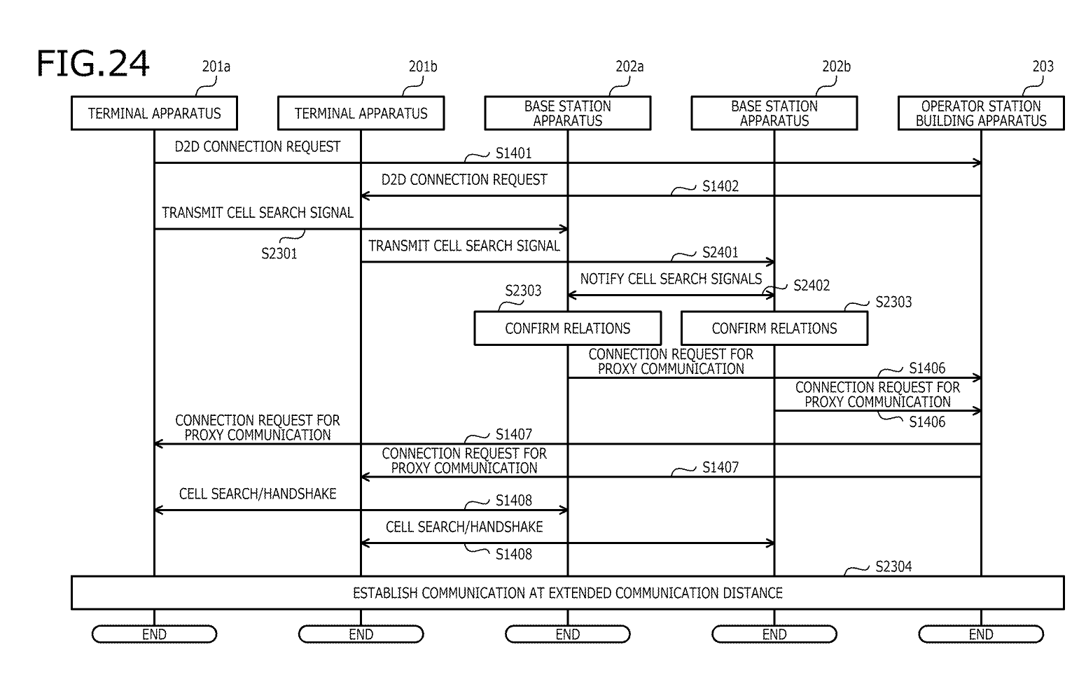

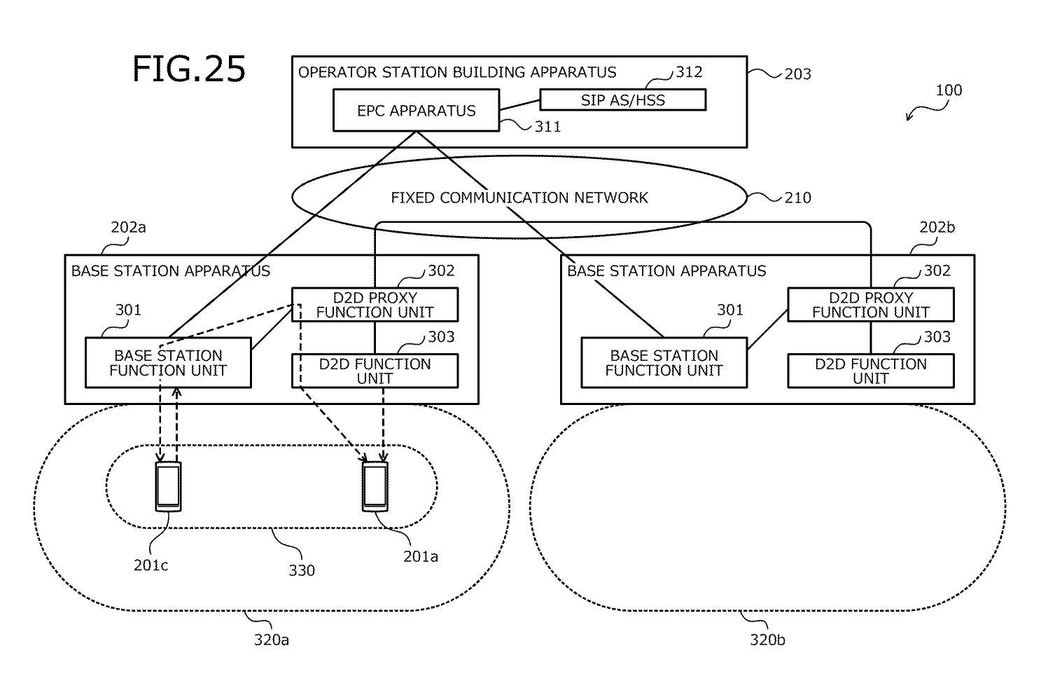

FIG. 24 is a sequence diagram of an example of an operation of starting the respective proxy communications at the base station of the base station apparatus 202a and another base station (e.g., the base station of the base station apparatus 202b). As depicted in FIG. 24, after steps S1401 and S1402, the terminal apparatus 201a transmits a cell search signal to the base station apparatus 202a (step S2301). The terminal apparatus 201b transmits a cell search signal to the base station apparatus 202b (step S2401). The terminal apparatus 201a and the terminal apparatus 201b are away from each other and cannot intercept the each other's cell search signals. The base station apparatus 202a and the base station apparatus 202b notify each other of the cell search signals (step S2402).

The base station apparatus 202a and the base station apparatus 202b each refer to the cell search signals to confirm the relations between the target terminal name and the source terminal name (step S2303). If the relations between the target terminal name and the source terminal name match each other, the base station apparatus 202a and the base station apparatus 202b make connection requests for proxy communication, to the operator station building apparatus 203 (step S1406).

Subsequently, steps S1407 to S1408 described above are executed to perform the proxy communications at the base station of the base station apparatus 202a and the other base station (e.g., the base station apparatus 202b) to establish a communication at an extended communication distance (step S2304). As described above, even when the D2D communication cannot be started between the terminal apparatus 201a and the terminal apparatus 201b, the proxy communications can be started by the same communication scheme used for D2D communication.

According to the third embodiment, even when the wireless propagation quality between the terminal apparatus 201a and the terminal apparatus 201b is too low to start the D2D communication, the proxy communication can be performed by the same communication scheme used for D2D communication. Therefore, even when the respective search signals cannot mutually reach the terminal apparatus 201a and the terminal apparatus 201b, the proxy communication can be started by the same communication scheme used for D2D communication and the communication area of the communication scheme used for D2D communication can be expanded.

The fourth embodiment will be described. In a configuration described in the fourth embodiment, the terminal apparatus 201 performing the proxy communication and a terminal apparatus 201 not supporting the D2D communication are allowed to communicate with each other. More particularly, if one of the terminal apparatuses 201 does not support the D2D communication, communication that effectively utilizes the wireless bandwidth cannot be performed by using the same communication scheme used for D2D communication even though the other terminal apparatus 201 supports the D2D communication. Therefore, in the fourth embodiment, description will be made of a case where a terminal apparatus 201 that performs proxy communication by the same communication scheme used for D2D communication and a terminal apparatus 201 that does not support the D2D communication communicate with each other.

An overview of the fourth embodiment will be described with reference to FIG. 1. The fourth embodiment is based on an assumption that the second terminal apparatus 120b does not have a function of performing direct wireless communication. As depicted in FIG. 1, the relaying unit 114 wirelessly communicates with the first terminal apparatus 120a by the same predetermined communication scheme used for the direct wireless communication (the D2D communication) without allowing the first terminal apparatus 120a to execute the direct wireless communication.

The relaying unit 114 wirelessly communicates with the second terminal apparatus 120b by a communication scheme (the communication with a base station) that differs from the predetermined communication scheme. The relaying unit 114 has a function of converting the communication scheme for the D2D communication and the communication scheme for the communication with a base station. For example, the relaying unit 114 converts the communication scheme for D2D communication into the communication scheme for communication with a base station for transmissions to the second terminal apparatus 120b and converts the communication scheme for communication with a base station into the communication scheme for D2D communication for transmissions to the first terminal apparatus 120a.

If the second terminal apparatus 120b is connected to another base station apparatus, the relaying unit 114 wirelessly communicates with the first terminal apparatus 120a by the predetermined communication scheme without allowing the first terminal apparatus 120a to perform the direct wireless communication. Additionally, the relaying unit 114 communicates with the second terminal apparatus 120b via the other base station apparatus, thereby relaying the communication between the first terminal apparatus 120a and the second terminal apparatus 120b. As a result, even when the second terminal apparatus 120b without a function of the D2D communication is located in the communication area of another base station apparatus, the second terminal apparatus 120b can communicate with the first terminal apparatus 120a, which communicates by the communication scheme used for D2D communication.

FIG. 25 is an explanatory diagram of an overview of communication in the wireless access system according to the fourth embodiment. In FIG. 25, a terminal apparatus 201c does not support the D2D communication and does not have, for example, a functional unit performing the D2D communication. The terminal apparatus 201a supports the D2D communication and can perform the D2D communication between the terminal apparatuses 201 and the proxy communication via the base station apparatus 202a.

Both the terminal apparatus 201a and the terminal apparatus 201c are assumed to be located in the communication area 320a of the base station apparatus 202a. Since the terminal apparatus 201c does not support the D2D communication, the terminal apparatus 201a and the terminal apparatus 201c cannot perform D2D communication therebetween. Therefore, the base station apparatus 202a performs the function of the D2D communication as a proxy of the terminal apparatus 201c to enable communication with the terminal apparatus 201a that performs the proxy communication.

For example, the terminal apparatus 201c connects to and communicates with the base station function unit 301 by the communication scheme for communication with a base station. The base station function unit 301 outputs to the D2D proxy function unit 302, data received from the terminal apparatus 201c. The D2D proxy function unit 302 converts the signal received from the base station function unit 301 into a signal for the communication scheme for the D2D communication. The D2D proxy function unit 302 outputs to the D2D function unit 303, the signal converted for the D2D communication. The D2D function unit 303 connects to and communicates with the terminal apparatus 201a by the communication scheme for the D2D communication.

The D2D function unit 303 connects to and communicates with the terminal apparatus 201a by the communication scheme for the D2D communication. The D2D function unit 303 outputs to the D2D proxy function unit 302, a signal received from the terminal apparatus 201a. The D2D proxy function unit 302 converts the data received from the D2D function unit 303 into data for the communication scheme for communication with a base station. The D2D proxy function unit 302 outputs to the base station function unit 301, the signal converted for communication with a base station. The base station function unit 301 communicates by the communication scheme for communication with a base station.

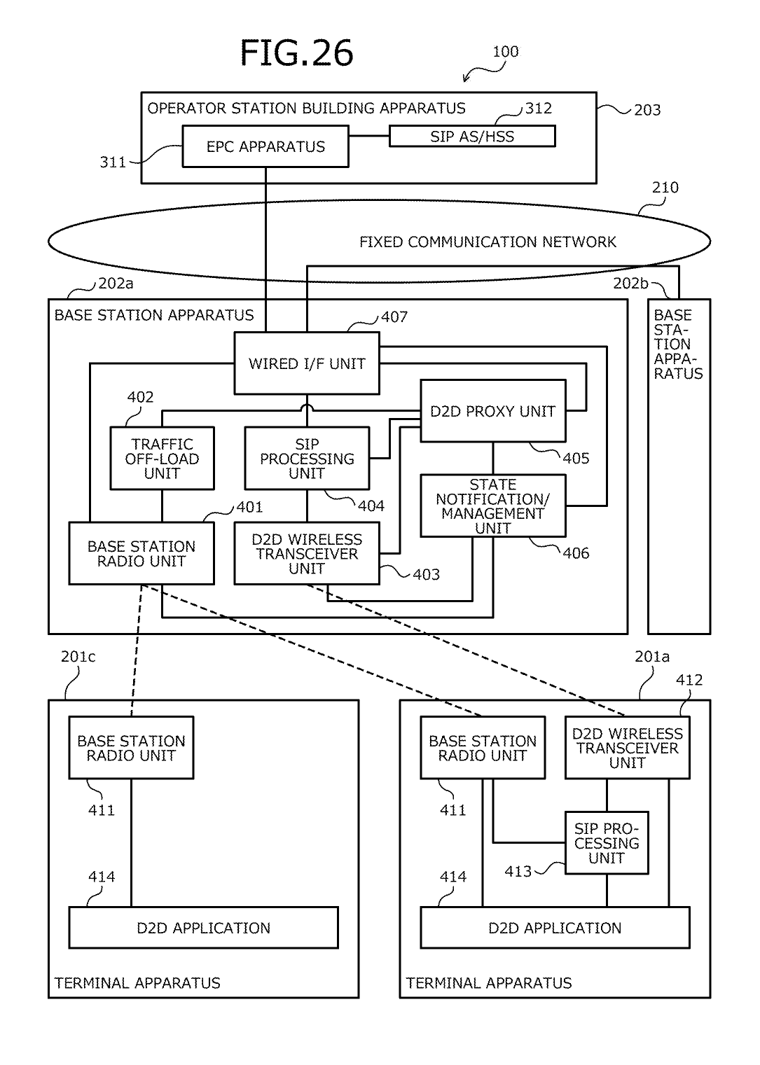

FIG. 26 is a block diagram of a specific example of a functional configuration of the wireless access system according to the fourth embodiment. As depicted in FIG. 26, the terminal apparatus 201c is, for example, a computer apparatus supporting the LTE mode or the LTE-A scheme and is, a mobile terminal such as a smartphone, for example. The terminal apparatus 201c has an application execution area. The terminal apparatus 201c has the radio unit 411 and the D2D application 414.

The D2D application 414 is an application deployed in the application execution area of the terminal apparatus 201c. The D2D application 414 is installed for communicating with the terminal apparatus 201a that performs the proxy communication. The D2D application 414 is connected via the radio unit 411, the base station radio unit 401, and the traffic off-load unit 402 to the D2D proxy unit 405.

The SIP processing unit 404 executes a SIP signaling process to communicate via the D2D wireless transceiver unit 403 with the terminal apparatus 201a that supports the D2D in the communication area of the base station of the base station apparatus 202a, by the communication scheme for the D2D communication. The SIP processing unit 404 can also communicate with the terminal apparatus 201 that supports the D2D in the communication area of another base station, by the communication scheme for the D2D communication and, in this case, the communication is performed via the wired I/F unit 407.

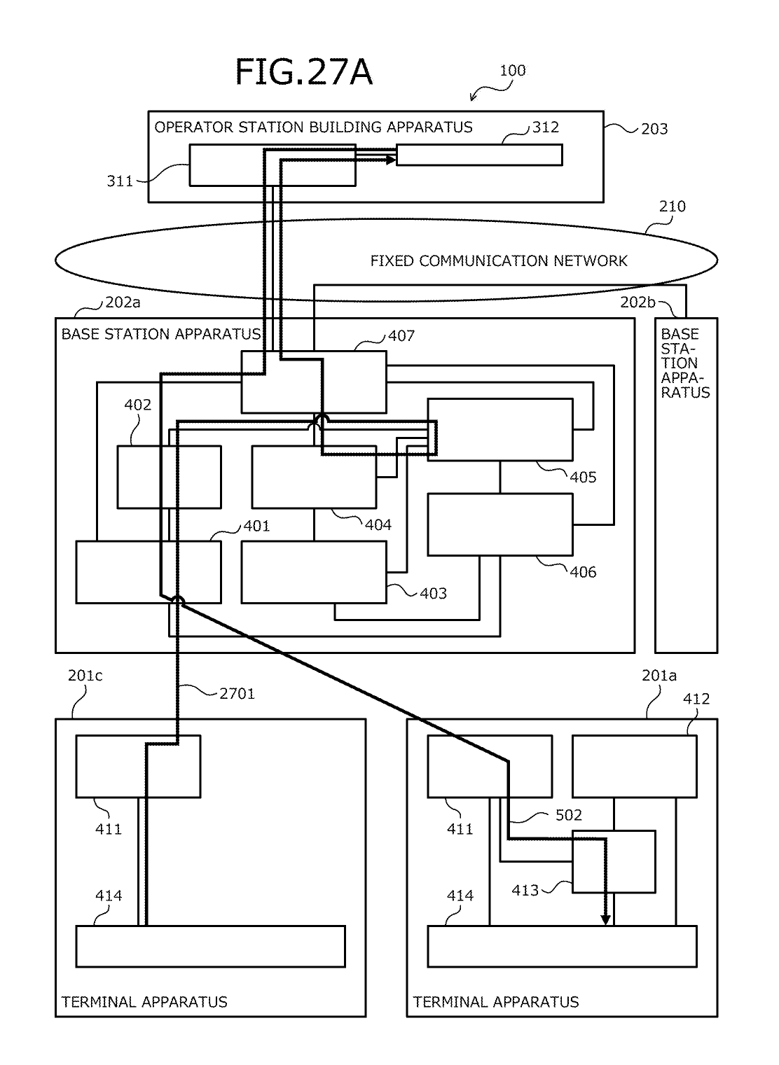

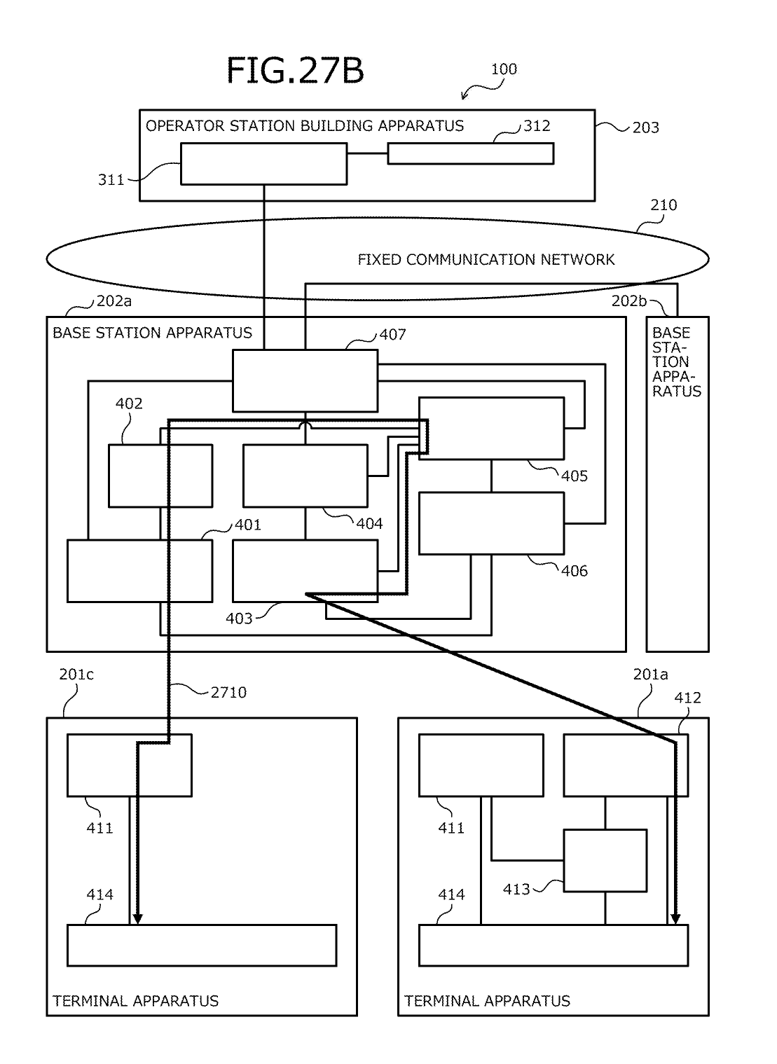

FIG. 27A is an explanatory diagram of an example (part 1) of communication paths in the wireless access system according to the fourth embodiment. In FIG. 27A, the names of the functional units are omitted. The D2D application 414 is assumed to be executed by a user operation at the terminal apparatus 201c. As a result, the terminal apparatus 201c accesses the SIP processing unit 404 via the radio unit 411→the base station radio unit 401→the traffic off-load unit 402→the D2D proxy unit 405 as indicated by arrow 2701 to make a connection request for the D2D communication. The SIP processing unit 404 accesses the SIP AS/HSS 312 via the wired I/F unit 407→the EPC apparatus 311.

The operator station building apparatus 203 calls the terminal apparatus 201a via the EPC apparatus 311→the wired I/F 407→the base station radio unit 401→the radio unit 411→the SIP processing unit 413 as indicated by arrow 502. As a result, communication is established.

FIG. 27B is an explanatory diagram of an example (part 2) of communication paths in the wireless access system according to the fourth embodiment. In FIG. 27B, the names of the functional units are omitted. After the communication is established, data is communicated via the D2D proxy unit 405. For example, as indicated by arrow 2710, a signal from the terminal apparatus 201c is transmitted via the base station radio unit 401→the traffic off-load unit 402→the D2D proxy unit 405→the D2D wireless transceiver unit 403 to the terminal apparatus 201a. A signal from the terminal apparatus 201a is transmitted through the reverse path to the terminal apparatus 201c.

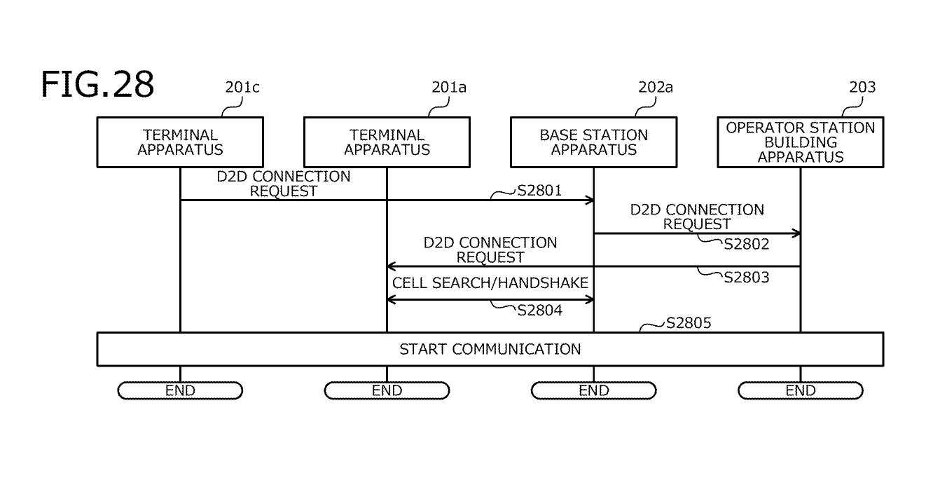

FIG. 28 is a sequence diagram of an example of an operation of allowing a terminal apparatus that performs D2D communication and a terminal apparatus that does not support the D2D communication to communicate with each other. As depicted in FIG. 28, the terminal apparatus 201c makes a connection request for the D2D communication to the base station apparatus 202a (step S2801). Although the terminal apparatus 201c is made to appear on the application as if the terminal apparatus 201c performs the D2D communication, the terminal apparatus 201c supports neither the D2D communication nor the proxy communication and therefore, does not perform the D2D communication or the proxy communication. The communication between the terminal apparatus 201c and the base station apparatus 202a is always performed by the communication scheme for communication with a base station.

When receiving the connection request for the D2D communication from the terminal apparatus 201c, the base station apparatus 202a makes a connection request for the D2D communication to the operator station building apparatus 203 (step S2802). The operator station building apparatus 203 makes a D2D connection request to the terminal apparatus 201a (step S2803). The terminal apparatus 201a and the base station apparatus 202a execute a cell search and handshake (step S2804) and perform the proxy communication.

As a result, the wireless access system 100 starts communication between the terminal apparatus 201a that performs the proxy communication and the terminal apparatus 201c that does not support the D2D communication (step S2805). Therefore, the terminal apparatus 201c that does not support the D2D communication can be made to be compatible with the D2D communication by installing the D2D application 414 and can be made to appear as if the terminal apparatus 201c performs the D2D communication.

The fourth embodiment enables a terminal apparatus 201 that performs the proxy communication by the communication scheme used for D2D communication and a terminal apparatus 201 that does not support the D2D communication to communicate with each other. Therefore, compatibility can be achieved between the terminal apparatuses 201a, 201c. Additionally, for the terminal apparatus 201 that performs the proxy communication by the communication scheme used for D2D communication, communication that effectively utilizes the wireless band can be performed.

According to one aspect of the present invention, an effect is achieved in that the base station can directly manage communications between terminal apparatuses.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A base station apparatus comprising:
a receiving circuit configured to receive from a first terminal apparatus, a start request for direct wireless communication between the first terminal apparatus and a second terminal apparatus; and
a transmitting circuit configured transmit to the first terminal apparatus and the second terminal apparatus after the receiving circuit receives the start request, a control signal allowing the first terminal apparatus and the second terminal apparatus to mutually transmit signals so as to establish the direct wireless communication.

2. The base station apparatus according to claim 1, further comprising:
an obtaining circuit configured to obtain information that indicates wireless propagation quality between the first terminal apparatus and the second terminal apparatus; and
a relaying circuit configured to relay communication between the first terminal apparatus and the second terminal apparatus, when the wireless propagation quality indicated by the obtained information fails to satisfy a predetermined condition, the relaying circuit relaying the communication by wirelessly communicating with the first terminal apparatus and the second terminal apparatus by a predetermined communication scheme used for the direct wireless communication and not allowing the first terminal apparatus and the second terminal apparatus to execute the direct wireless communication.

3. The base station apparatus according to claim 2, wherein
the relaying circuit starts relaying the communication without starting the direct wireless communication, when the wireless propagation quality fails satisfy the predetermined condition when the receiving circuit receives the start request.

4. The base station apparatus according to claim 2, wherein
the obtaining circuit obtains the information that indicates the wireless propagation quality during the direct wireless communication, and
the relaying circuit terminates the direct wireless communication and starts relaying the communication, when the wireless propagation quality fails to satisfy the predetermined condition during the direct wireless communication.

5. The base station apparatus according to claim 2, wherein
the obtaining circuit obtains the information that indicates a first wireless propagation quality between the base station apparatus and the second terminal apparatus and a second wireless propagation quality between a first base station apparatus and the second terminal apparatus,
the relaying circuit, in relaying the communication between the first terminal apparatus and the second terminal apparatus when the wireless propagation quality between the first terminal apparatus and the second terminal apparatus fails to satisfy the predetermined condition, switches a first relay method of wirelessly communicating with the first terminal apparatus and communicating with the second terminal apparatus via the first base station apparatus, and a second relay method of wirelessly communicating with the first terminal apparatus and the second terminal apparatus, the relaying circuit switching the first relay method and the second relay method according to a result of comparison of the first wireless propagation quality and the second wireless propagation quality indicated by the obtained information.

6. The base station apparatus according to claim 1, further comprising:
an obtaining circuit configured to obtain information that indicates availability of a line for communicating with the first terminal apparatus and a line for communicating with the second terminal apparatus, by a predetermined communication scheme used for the direct wireless communication; and
a relaying circuit configured to relay communication between the first terminal apparatus and the second terminal apparatus by wirelessly communicating with the first terminal apparatus and the second terminal apparatus by the predetermined communication scheme, when the obtained information indicates availability of a line for communicating with the first terminal apparatus and a line for communicating with the second terminal apparatus.

7. The base station apparatus according to claim 1, further comprising:
a relaying circuit configured to relay communication between the first terminal apparatus and the second terminal apparatus by concurrently using a first line formed by wirelessly communicating with the first terminal apparatus and the second terminal apparatus by a predetermined communication scheme used for the direct wireless communication, and a second line formed by wirelessly communicating with the first terminal apparatus and the second terminal apparatus by a communication scheme that differs from the predetermined communication scheme.

8. The base station apparatus according to claim 1, further comprising
a relaying circuit configured to relay communication between the first terminal apparatus and the second terminal apparatus, when the second terminal apparatus lacks a function of performing the direct wireless communication, the relaying circuit relaying the communication by not allowing execution of the direct wireless communication and by wirelessly communicating with the first terminal apparatus by a predetermined communication scheme used for the direct wireless communication and wirelessly communicating with the second terminal apparatus by a communication scheme that differs from the predetermined communication scheme.

9. A terminal apparatus comprising:
a transmitting circuit configured to transmit to a base station apparatus, a start request for direct wireless communication between the terminal apparatus and a first terminal apparatus;
a receiving circuit configured to receive from the base station apparatus, a control signal related to establishing the direct wireless communication, the control signal being received after the transmitting circuit transmits the start request; and
a control circuit configured to exchange signals with the second terminal apparatus, in response to the receiving circuit receiving the control signal and so as to establish the direct wireless communication.

10. A wireless access system comprising:
a first terminal apparatus configured to transmit to a base station apparatus, a start request for direct wireless communication between the first terminal apparatus and a second terminal apparatus; and
the base station apparatus configured to transmit to the first terminal apparatus and the second terminal apparatus, a control signal related to establishing the direct wireless communication, the base station apparatus transmitting the control signal after receiving the start request from the first terminal apparatus, wherein
the first terminal apparatus, in response to the control signal received from the base station apparatus, exchanges signals with the second terminal apparatus so as to establish the direct wireless communication.
